(19) United States
(12) Patent Application Publication
(10) Pub. No.: US 2024/0340546 A1
(43) Pub. Date: Oct. 10, 2024

(54) SOLID-STATE IMAGING DEVICE

(71) Applicant: Sony Semiconductor Solutions Corporation, Kanagawa (JP)

(72) Inventor: Kumiko Mahara, Kanagawa (JP)

(21) Appl. No.: 18/578,436

(22) PCT Filed: Mar. 16, 2022
(86) PCT No.: PCT/JP22/11906

§ 371 Date: Jan. 11, 2024

(30) Foreign Application Priority Data
Sep. 2, 2021 (JP) 2021-143405

(51) Int. Cl. H04N 25/40; H04N 25/585; H04N 25/772

(52) U.S. Cl. CPC H04N 25/40; H04N 25/585; H04N 25/772

(57) ABSTRACT

[Problem] To improve the framerate of HDR compositing.

[Solution] A solid-state imaging device includes a region classification circuit, an exposure time determination circuit, and an exposure control circuit. The region classification circuit divides pixels arranged in an array into each of predetermined regions and classifies each of the predetermined regions obtained by the dividing into a long accumulation region for a long exposure and a short accumulation region for a short exposure. The exposure time determination circuit determines an exposure time of the long accumulation region and an exposure time of the short accumulation region classified. The exposure control circuit controls exposure times of the pixels for each of the predetermined regions based on the exposure times determined.

### TECHNICAL FIELD

The present disclosure relates to a solid-state imaging device.

### BACKGROUND ART

Solid-state imaging devices using global shutter techniques are currently in wide use. “Global shutter” refers to a technique in which light-receiving pixels are provided with memories to enable an image of a single frame to be obtained for each pixel simultaneously.

High Dynamic Range (HDR) technology is often required for solid-state imaging devices. “HDR” refers to a technique that secures the dynamic range for both bright and dark regions when such regions are present in an image.

Although it is desirable for a device equipped with a global shutter to have HDR functionality, the global shutter cannot store subsequent data in the memory until the previous data is output from the memory. For this reason, the framerate at which data can be output from the sensor is limited, and it is difficult to reduce the frame time to less than a certain length of time. In HDR, processing is executed on the basis of pixel information obtained from long exposure (long accumulation) and pixel information obtained from short exposure (short accumulation), but with a global shutter, there is a time gap between the timings of these exposures, and artifacts can therefore arise. There is a further problem in that the framerate is limited to output all the data of the long accumulations and short accumulations.

### CITATION LIST

### Patent Literature

[PTL 1] WO 2019/069532

### SUMMARY

### Technical Problem

Accordingly, the present disclosure provides a solid-state imaging device that performs high-precision HDR processing for a global shutter.

### Solution to Problem

According to one embodiment, a solid-state imaging device includes a region classification circuit, an exposure time determination circuit, and an exposure control circuit. The region classification circuit divides pixels arranged in an array into each of predetermined regions and classifies each of the predetermined regions obtained by the dividing into a long accumulation region for a long exposure and a short accumulation region for a short exposure. The exposure time determination circuit determines an exposure time of the long accumulation region and an exposure time of the short accumulation region classified. The exposure control circuit controls exposure times of the pixels for each of the predetermined regions based on the exposure times determined.

The solid-state imaging device may further include a distance detection circuit that generates a range image for an image obtained by the pixels, and the region classification circuit may classify the predetermined regions based on the range image.

The solid-state imaging device may further include a luminance detection circuit that detects a luminance value of each of the pixels, and the exposure time determination circuit may determine the exposure time of the long accumulation region and the exposure time of the short accumulation region based on each of the luminance values.

The solid-state imaging device may further include a histogram generation circuit that generates a histogram of pixel values obtained by the pixels for each of the predetermined regions, and the region classification circuit may classify the regions based on each of the histograms generated.

The exposure time determination circuit may determine the exposure time of the long accumulation region and the exposure time of the short accumulation region based on the histograms.

The readout of pixel values from the pixels may be executed through a global shutter method.

The solid-state imaging device may further include a readout control circuit that controls a readout timing for each of the predetermined regions classified.

Each of the pixels may include a pixel memory storing a photoelectrically-converted analog signal, and the readout control circuit may control a timing of outputting pixel data from each of the pixel memories.

The solid-state imaging device may further include an Analog to Digital Converter (ADC) shared by the pixels belonging to a corresponding one of the predetermined regions.

The long accumulation region and the short accumulation region may be able to be set to overlap.

Pixels that receive infrared light may be provided as the pixels, and the infrared light may be received by the pixels that receive the infrared light at a timing at which a long exposure is performed in the long accumulation region.

The solid-state imaging device may further include an LED that emits the infrared light.

All the predetermined regions may be classified as the short accumulation region.

### BRIEF DESCRIPTION OF DRAWINGS

FIG. 1 is a diagram schematically illustrating a semiconductor substrate according to an embodiment.

FIG. 2 is a diagram schematically illustrating a semiconductor substrate according to an embodiment.

FIG. 3 is a diagram schematically illustrating a part of circuitry in the periphery of a pixel according to an embodiment.

FIG. 4 is a diagram schematically illustrating a part of a pixel circuit according to an embodiment.

FIG. 5 is a timing chart illustrating an overview of data transfer in a solid-state imaging device according to an embodiment.

FIG. 6 is a timing chart illustrating an overview of data transfer in a solid-state imaging device according to a comparative example.

FIG. 7 is a diagram illustrating an example of a captured image.

FIG. 8 is a diagram illustrating an example of an ROI according to an embodiment.

FIG. 9 is a diagram illustrating an example of a unit by which an ROI is set according to an embodiment.

FIG. 10 is a diagram illustrating an example of an ROI according to an embodiment.

FIG. 11 is a diagram illustrating an example of an ROI according to an embodiment.

FIG. 12 is a diagram illustrating a long accumulation region according to an embodiment.

FIG. 13 is a diagram illustrating a short accumulation region according to an embodiment.

FIG. 14 is a flowchart illustrating processing according to an embodiment.

FIG. 15 is a diagram schematically illustrating an example of embedding image plane phase difference pixels according to an embodiment.

FIG. 16 is a block diagram schematically illustrating the solid-state imaging device according to an embodiment.

FIG. 17 is a diagram illustrating an example of a histogram of luminance values in a region.

FIG. 18 is a diagram illustrating an example of a histogram of luminance values in a region.

FIG. 19 is a diagram illustrating an example of a histogram of luminance values in a region.

FIG. 20 is a flowchart illustrating processing according to an embodiment.

FIG. 21 is a block diagram schematically illustrating the solid-state imaging device according to an embodiment.

FIG. 22 is a timing chart illustrating an overview of data transfer in the solid-state imaging device according to an embodiment.

FIG. 23 is a diagram illustrating an example of an ROI according to an embodiment.

FIG. 24 is a diagram illustrating an example of the implementation of an image sensor according to an embodiment.

FIG. 25 is a diagram illustrating an example of the implementation of an image sensor according to an embodiment.

FIG. 26 is a diagram illustrating an example of the implementation of an image sensor according to an embodiment.

FIG. 27 is a block diagram illustrating an example of the overall configuration of a vehicle control system.

FIG. 28 is an explanatory diagram illustrating an example of positions at which a vehicle exterior information detector and an image capturing unit are installed.

Embodiments of the present disclosure will be described below with reference to the accompanying drawings. The drawings are used for illustrative purposes, and do not always agree with the shapes and sizes of the configurations of units in an actual device or size ratios or the like relative to other configurations in the actual device. Since the drawings are simplified, configurations that are not illustrated but are necessary for implementation are assumed to be provided as appropriate.

A non-limiting implementation in an Analog to Digital Converter (ADC) for realizing the content of the present disclosure will be described first.

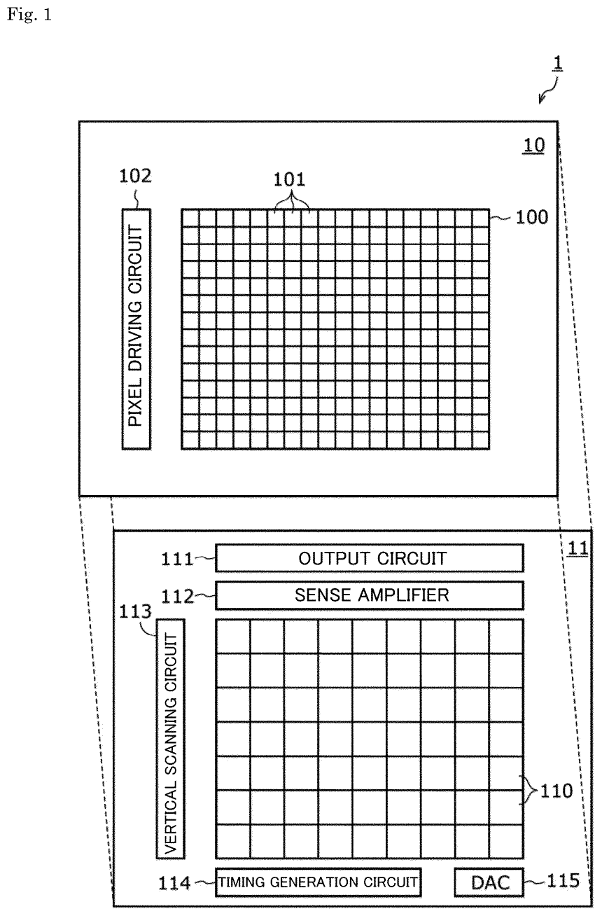

FIG. 1 is a diagram illustrating an example in which an ADC is provided for each of regions in a pixel array in which image capturing pixels are arranged in an array.

A semiconductor substrate 1 includes a first substrate 10 and a second substrate 11. The first substrate 10 and the second substrate 11 may be configured as stacked semiconductor chips, for example, as will be described in detail below. Although not illustrated, the first substrate 10 and the second substrate 11 are stacked with an insulating layer provided therebetween, and a conductor (a metal such as Cu, for example, but not limited thereto) is provided within this insulating layer such that appropriate locations in each substrate are electrically connected to each other. The respective substrates may be semiconductor substrates using Si, for example.

The semiconductor substrate 1 is formed as a semiconductor chip constituting a light-receiving unit in a solid-state imaging device, for example.

The first substrate 10 includes a pixel array 100 and a pixel driving circuit 102.

Pixels 101 are disposed in a two-dimensional array in the pixel array 100. Each pixel 101 includes a light-receiving element (a photoelectric conversion element) such as a photodiode (PD), for example, and each pixel 101 photoelectrically converts light received by the light-receiving element and outputs an analog signal. Pixel circuitry and the like required for output may also be provided. In the present disclosure, a memory region storing a charge generated according to the intensity of the light received may be provided in the light-receiving element constituting each pixel 101. Aside from a generic PD, the light-receiving element may be an Avalanche Photo Diode (APD), a Single Photon Avalanche Diode (SPAD), or an organic photoelectric conversion film, for example.

The pixel driving circuit 102 is a circuit that drives the pixels 101. By applying a suitable voltage to the anodes of the photodiodes provided in the pixels 101, the pixel driving circuit 102 puts the pixels 101 into a standby state, and then drives the pixels 101 to perform photoelectric conversion at an appropriate timing, for example. Circuitry for controlling transfers from the memories may also be provided, and this transfer circuitry may be provided separately.

Driven by the pixel driving circuit 102, the pixels 101 output analog signals according to the intensity of the light received thereby to the second substrate 11.

The second substrate 11 includes an ADC 110, an output circuit 111, a sense amplifier 112, a vertical scanning circuit 113, a timing generation circuit 114, and a Digital to Analog Converter (DAC) 115.

The ADC 110 is disposed according to positions corresponding to the pixels 101 of the first substrate 10. In the example in FIG. 1, the ADC 110 is provided for every 2×2 pixels 101. In this case, by having a single ADC 110 processing four pixels 101 and operating the ADCs 110 in parallel, each ADC 110 executes AD conversion for four pixels. The foregoing is provided as a non-limiting example, and the number of pixels 101 corresponding to one ADC 110 may be lower or higher.

The output circuit 111 outputs a digital signal based on the intensity of the light received by the pixel 101 and AD-converted in the second substrate 11.

The sense amplifier 112 is a circuit that suitably amplifies the output of the ADC 110, and amplifies a digital signal based on the intensity of the light received by the pixel 101 output from the ADC 110. The amplified signal is then output through the output circuit 111.

The vertical scanning circuit 113 is a circuit that controls the timing of outputting the signals from the pixels 101. The vertical scanning circuit 113 outputs digital signals in order from the output circuit 111 as appropriate by, for example, selecting the ADCs 110 on a line-by-line basis.

The timing generation circuit 114 is a circuit that generates signals for controlling timings related to the pixels 101 and the output. The constituent elements of the semiconductor substrate 1 execute various controls at the timings output by the timing generation circuit 114.

The DAC 115 is a circuit that generates analog signals for use in the AD conversion by the ADC 110. For example, the DAC 115 converts an input clock signal into an analog signal as appropriate, converts that signal into an analog signal used in a counter circuit or the like in the ADC 110, and outputs the analog signal. The DAC 115 converts a predetermined digital signal to generate an analog ramp signal, for example. The clock signal is output for an appropriate time by inputting the ramp signal to a comparison circuit of the ADC 110, and the number of clock signals output is added and subtracted as appropriate by a counter circuit and counted to output a digital signal based on the pixel value.

The specific operations for converting an analog signal to a digital signal in the ADC 110 are the same as those performed in a general ADC, and will therefore not be described here. As described above, the ADC 110 converts analog signals output from the pixels 101 included in a predetermined area into digital signals. The pixels 101 included in the area share a floating diffusion (FD), for example. The AD conversion can be executed as appropriate by controlling the transfer from the memories provided in the light-receiving elements of the pixels 101.

In such a configuration, the ADCs operate in units that are finer than in a case where ADCs are provided in each column of the pixels 101, for example, which makes it possible to obtain suitable digital signals in finer image regions at a higher speed and/or with a better accuracy.

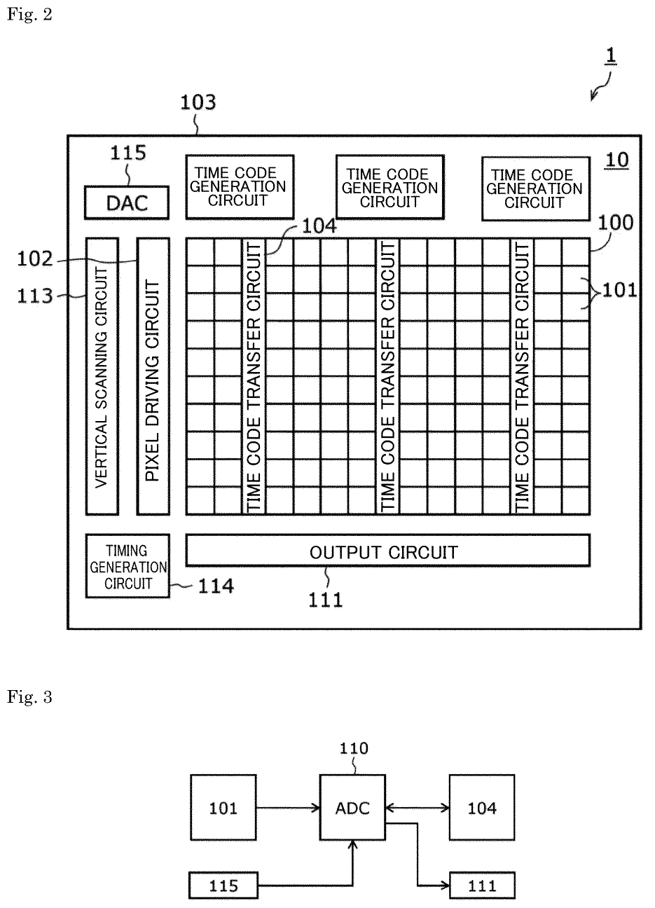

FIG. 2 is a diagram illustrating another example in which an ADC is provided for each of regions in a pixel array in which image capturing pixels are arranged in an array. FIG. 2 is a diagram illustrating a configuration that can be used in an aspect of the present disclosure when an ADC is provided for each pixel.

The semiconductor substrate 1 is configured including the first substrate 10, for example. The first substrate 10 includes the pixel array 100, the pixel driving circuit 102, a time code generation circuit 103, a time code transfer circuit 104, the output circuit 111, the vertical scanning circuit 113, the timing generation circuit 114, and the DAC 115. Reference signs that are the same as in FIG. 1 are the same constituent elements and will therefore not be described in detail.

Although the output circuit 111, the vertical scanning circuit 113, the timing generation circuit 114, and the DAC 115 are disposed in the first substrate 10 in FIG. 2, it should be noted that these elements need not be provided in the first substrate 10 in the same manner as in FIG. 1. The semiconductor substrate 1 may further include a second substrate, and the second substrate may be provided with suitable constituent elements as appropriate.

The time code generation circuit 103 is a circuit that generates a time code. The time code is stored along with information on the pixels.

The time code transfer circuit 104 is a circuit that outputs the time code generated by the time code generation circuit 103 to the pixels 101.

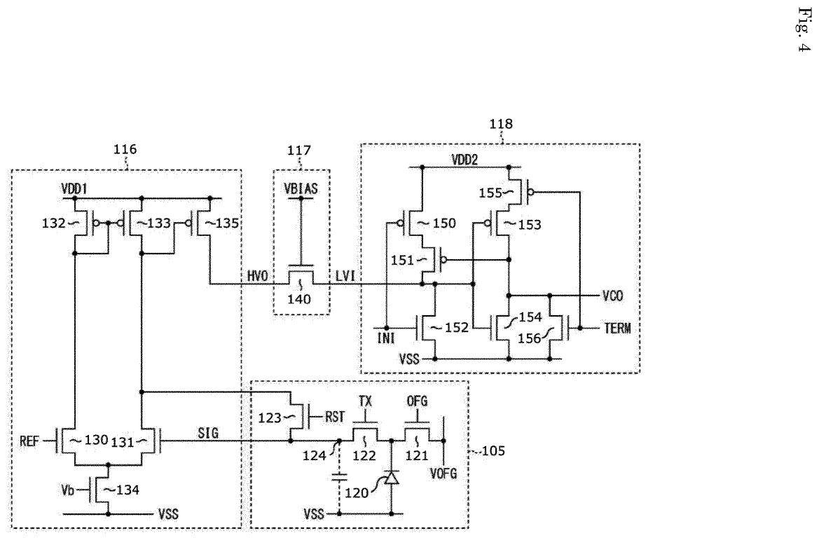

FIG. 3 is a diagram schematically illustrating an example of the connections of the pixels 101 disposed on the semiconductor substrate 1 in FIG. 2.

A signal obtained by photoelectrical conversion in the pixel 101 and appropriately stored and transferred in the pixel circuit (not shown) is input into the ADC 110. In the ADC 110, the analog signal output by the pixel 101 is appropriately converted into a digital signal based on the ramp signal output from the DAC 115, and is output at an appropriate timing through the output circuit 111.

The time code generated by the time code generation circuit 103 is stored along with the digital image signal in a storage unit (not shown) connected to the ADC 110. The storage unit includes a latch control circuit that controls time code write operations and read operations, and a latch storage circuit that stores the time code.

In the time code write operation, the latch control circuit stores the time code, which is updated every unit of time supplied from the time code transfer circuit 104, in the latch storage unit during a period when a High signal is being output from the comparison circuit in the ADC 110.

The storage of the time code ends when the signal output from the comparison circuit switches to Low at a timing when the magnitude relationship between the analog signal output from the pixel 101 and the ramp signal output from the DAC 115 switches.

The storage unit holds the time code stored in the latch storage unit, and the time code held indicates the timing when the magnitude relationship between the output of the pixel 101 and the ramp signal output by the DAC 115 switches in the ADC 110. Data indicating that the signal output from the pixel 101 at this timing was a reference voltage at that time, i.e., expresses a digitized light intensity value (the digital pixel signal).

A plurality of time code generation circuits 103 may be provided for the pixel array 100, and the pixel array 100 includes time code transfer circuits 104 corresponding to the number of time code generation circuits 103. In other words, the time code generation circuit 103 that generates the time code and the time code transfer circuit 104 that transfers the generated time code correspond to one-to-one.

The vertical scanning circuit 113 performs control for outputting the digital pixel signals generated in the pixels 101 to the output circuit 111 in a predetermined order based on the timing signals supplied from the timing generation circuit 114. The digital pixel signals output from the pixels 101 are output from the output circuit 111 to the exterior of the semiconductor substrate 1.

The output circuit 111 may execute other signal processing and image processing as appropriate before the output. The output circuit 111 executes predetermined digital signal processing, such as black level correction processing, Correlated Double Sampling (CDS) processing, color composition processing, color correction processing, missing pixel correction processing, and the like, for example. In addition, at least some of this processing may be implemented in the ADC 110 as long as the processing can be performed appropriately.

The pixel circuit (a circuit, not shown in FIG. 3, that is disposed between the pixels 101 and the ADC 110) outputs a charge signal based on the received light intensity to the ADC 110 as an analog pixel signal. The ADC 110 converts the analog pixel signal SIG supplied from the pixel circuit into a digital signal.

As described above, the ADC 110 includes a comparison circuit and a storage unit, for example.

The comparison circuit compares the analog pixel signal with a reference signal supplied from the DAC 115, and outputs an output signal as a comparison result signal expressing the result of the comparison. The comparison circuit inverts the output signal at a timing at which the reference signal (the ramp signal) and the pixel signal are the same voltage.

For example, the comparison circuit is constituted by a differential input circuit, a voltage conversion circuit, and a positive feedback circuit, but the configuration is not limited thereto, and may be any circuit capable of comparing the analog pixel signal with the reference signal and outputting a result as appropriate.

FIG. 4 is a diagram illustrating the circuit configuration described above in more detail. A configuration in which the ADC 110 is provided for each pixel 101 is illustrated in FIG. 4.

For each pixel 101, the semiconductor substrate 1 includes a pixel circuit 105, a differential input circuit 116, a voltage conversion circuit 117, and a positive feedback circuit 118. The analog signal output from the light-receiving element of the pixel 101 is amplified at an appropriate rate by the differential input circuit 116, and is appropriately converted by the voltage conversion circuit 117. The positive feedback circuit 118 then converts the comparison result into a signal and outputs the signal.

The pixel circuit 105 is a circuit that outputs the analog signal, which has been output by the pixel 101, at an appropriate timing, and is provided in the first substrate 10 or the second substrate 11, for example. The pixel circuit 105 includes a PD 120, a discharge transistor 121, a transfer transistor 122, a reset transistor 123, and a FD 124.

The PD 120 is the photoelectric conversion element in the pixel 101 described above, and generates an analog signal based on the intensity of the light received at the PD 120. As described above, the PD 120 may include a memory region. Providing a memory region makes it possible to implement global shutter operations.

The discharge transistor 121 is connected to the cathode of the PD 120, and is used to adjust an exposure period. Specifically, if the exposure period is to be started at a desired timing, the charge accumulated in the PD 120 up to that time is discharged by turning on the discharge transistor 121, and thus the exposure time is started after the discharge transistor 121 is turned off.

The transfer transistor 122 is connected between the cathode of the PD 120 and the FD 124, and transfers the charge generated by the PD 120 to the FD 124 at an appropriate timing.

The reset transistor 123 is connected between the FD 124 and the drain of a transistor 131 of the differential input circuit 116, and resets the charge held in the FD 124.

The FD 124 is connected to the gate of the transistor 131 of the differential input circuit 116. The transistor 131 of the differential input circuit 116 therefore operates as an amplifying transistor of the pixel circuit 105.

The source of the reset transistor 123 is connected to the gate of the transistor 131 of the differential input circuit 116 and to the FD 124, and the drain of the reset transistor 123 is connected to the drain of the transistor 131. There is therefore no fixed reset voltage for resetting the charge in the FD 124. This is because the reset voltage for resetting the FD 124 can be set as desired using a reference signal REF by controlling the circuit state of the differential input circuit 116, and because storing fixed pattern noise of the circuit in the FD 124 and performing CDS processing makes it possible to cancel out this noise component.

The differential input circuit 116 compares a pixel signal SIG output from the pixel circuit 105 in the pixel 101 with the reference signal REF output from the DAC 115, and outputs a predetermined signal (current) when the pixel signal SIG is higher than the reference signal REF.

The differential input circuit 116 includes transistors 130 and 131 that form a differential pair, transistors 132 and 133 that form a current mirror, and a transistor 134 serving as a constant current source that supplies a current Icm according to an input bias current Vb.

The transistors 130, 131, and 134 are constituted by Negative Channel Metal-Oxide Semiconductors (nMOS) transistors, and the transistors 132, 133, and 135 are constituted by Positive channel MOS (pMOS) transistors.

Of the transistors 130 and 131 forming the differential pair, the reference signal REF output from the DAC 115 is input to the gate of the transistor 130, and the pixel signal SIG output from the pixel circuit 105 in the pixel 101 is input to the gate of the transistor 131.

The sources of the transistors 130 and 131 are connected to the drain of the transistor 134, and the source of the transistor 134 is connected to a predetermined voltage VSS (VSS<VDD2<VDD1).

The drain of the transistor 130 is connected to gates of the transistors 132 and 133 that constitute a current mirror and to the drain of the transistor 132, and the drain of the transistor 131 is connected to the drain of the transistor 133 and the gate of the transistor 135. The sources of the transistors 132, 133, and 135 are connected to a first power source voltage VDD1.

The voltage conversion circuit 117 is constituted by an nMOS transistor 140, for example.

The drain of the transistor 140 is connected to the drain of the transistor 135 in the differential input circuit 116, the source of the transistor 140 is connected to a predetermined node in the positive feedback circuit 118, and the gate of the transistor 140 is connected to a bias voltage VBIAS.

The transistors 130, 131, 132, 133, 134, and 135 provided in the differential input circuit 116 are circuits that operate at high voltages up to the first power source voltage VDD1, and the positive feedback circuit 118 is a circuit that operates at a second power source voltage VDD2 that is lower than the first power source voltage VDD1. The voltage conversion circuit 117 converts an output signal HVO input from the differential input circuit 116 into a constant voltage signal (a converted signal LVI) with which the positive feedback circuit 118 can operate, and supplies that signal to the positive feedback circuit 118.

The bias voltage VBIAS may be any voltage for converting to a voltage at which the transistors 150, 151, 152, 153, and 154 of the positive feedback circuit 118 operating at a constant voltage do not break down. The bias voltage VBIAS may be, for example, the same voltage as the second power source voltage VDD2 of the positive feedback circuit 118, i.e., VBIAS=VDD2.

On the basis of the converted signal LVI obtained by converting the output signal HVO from the differential input circuit 116 into a signal corresponding to the second power source voltage VDD2, the positive feedback circuit 118 outputs a comparison result signal that is inverted when the pixel signal SIG is higher than the reference signal REF. In addition, the positive feedback circuit 118 increases the transition speed for this inversion when an output signal VCO to be output as the comparison result signal is inverted.

The positive feedback circuit 118 includes transistors 150, 151, 152, 153, 154, 155, and 156. Here, the transistors 150, 151, 153, and 155 are pMOS transistors, and the transistors 152, 154, and 156 are nMOS transistors.

The source of the transistor 140, which is an output terminal of the voltage conversion circuit 117, is connected to the drains of the transistors 151 and 152 and the gates of the transistors 153 and 154. The source of the transistor 150 is connected to the second power source voltage VDD2, the drain of the transistor 150 is connected to the source of the transistor 151, and the gate of the transistor 151 is connected to the drains of the transistors 153 and 154 which also serve as output terminals of the positive feedback circuit 118.

The sources of the transistors 152, 154, and 156 are connected to the predetermined voltage VSS. An initialization signal INI is supplied to the gates of the transistors 150 and 152. A control signal TERM, which is a second input different from the converted signal LVI serving as a first input, is supplied to the gate of the transistor 155 and the gate of the transistor 156.

The source of the transistor 156 is connected to the second power source voltage VDD2, and the drain of the transistor 155 is connected to the source of the transistor 153. The drain of the transistor 156 is connected to the output terminal of the comparison circuit in the ADC 110, and the source of the transistor 156 is connected to the predetermined voltage VSS.

In the comparison circuit configured in this manner, setting the control signal TERM, which is the second input, to High makes it possible to set the output signal VCO to Low regardless of the state of the differential input circuit 116.

For example, when the voltage of the pixel signal SIG falls below a final voltage of the reference signal REF due to unexpectedly high luminance, a comparison period is ended with the output signal VCO from the comparison circuit remaining High. As a result, the data storage unit controlled by the output signal VCO cannot fix the value, and the AD conversion function does not work properly.

To prevent such a situation from occurring, the control signal TERM at a High pulse is input at the end of the sweep of the reference signal REF, which forces the output signal VCO, which has not yet inverted to Low, to invert. Since the data storage unit latches the clock time code immediately before the forced inversion, when the configuration illustrated here is used, the ADC 110 ultimately functions as an AD converter in which the output value is clamped with respect to an input at least a set luminance.

When the bias voltage VBIAS is controlled to Low level, the transistor 140 is disconnected, and when the initialization signal INI is set to High, the output signal VCO changes to High regardless of the state of the differential input circuit 116. Therefore, the output signal VCO can be set to any desired value regardless of the state of the differential input circuit 116, as well as the states of the pixel circuit 105 and the DAC 115 in the stages previous thereto, by combining the forced High output of the output signal VCO and with the forced Low output based on the aforementioned control signal TERM.

This operation also makes it possible, for example, to test circuits at stages after the pixel 101 using only the electrical signal input, without relying on optical inputs to the solid-state imaging device.

Although FIG. 4 illustrates a circuit that includes an ADC for each pixel, this technique can also be applied to a circuit that includes an ADC for each of regions, as illustrated in FIG. 1. For example, in FIG. 4, the transfer transistor 122 is connected to the plurality of pixels 101 at the common FD 124, which makes it possible to perform the AD conversion properly using a configuration that is common to the plurality of pixels 101.

The present disclosure can be implemented by using an ADC that executes AD conversion for each of the pixel regions described above, an ADC that executes AD conversion for each of the pixels, and the like. Of course, the technique is not limited to such an implementation, and it is sufficient for the configuration to include a circuit capable of executing AD conversion as appropriate.

### FIRST EMBODIMENT

A solid-state imaging device that realizes high-framerate and/or high-precision HDR compositing using the foregoing peripheral circuitry of the pixel 101 will be described next. First, the basic concepts of luminescence and exposure in the present disclosure will be described. In the present disclosure, a long-exposure region (called a “long accumulation region” hereinafter) and a short-exposure region (called a “short accumulation region” hereinafter) are set in the pixel array 100 of the solid-state imaging device for generating an HDR image. The solid-state imaging device generates an HDR image in which factors that may cause a drop in quality, such as motion blur, have little effect by appropriately processing the outputs from the pixels 101 belonging to long accumulation region and the short accumulation region that are set.

Using the global shutter method makes it possible for the solid-state imaging device to read out data for which exposure has been completed in sequence, which in turn makes it possible to appropriately change the timing of the readout on a frame-by-frame basis. A solid-state imaging device that uses Complementary MOS (CMOS) often has a framerate that is limited to the transfer speed from the FD in the pixel circuit.

For this reason, when a rolling shutter is used, even if regions are set and divided into a long accumulation region and a short accumulation region, the pixel signals are read out on a line-by-line basis and it is therefore difficult to change the times thereof from region to region. In addition, if, when the exposure time is changed and used on a line-by-line basis, short accumulation lines are to be processed before long accumulation lines, it is difficult set the pixels for long accumulation in terms of controlling the timings. Therefore, if even one long accumulation pixel is present, it is difficult to set the long accumulation and short accumulation pixels for each region, i.e., with all pixels becoming long accumulation pixels, and thus long accumulation or short accumulation is set for all the pixels in each frame. As a result, it is necessary to perform at least two frames' worth of transfer for all pixels for the purpose of HDR compositing.

In the present disclosure, this transfer time can be shortened by setting regions using a global shutter as appropriate.

FIG. 5 is a diagram schematically illustrating a timing chart of a solid-state imaging device using a global shutter that sets an exposure time for each of regions (Regions of Interest; ROI), focusing on data.

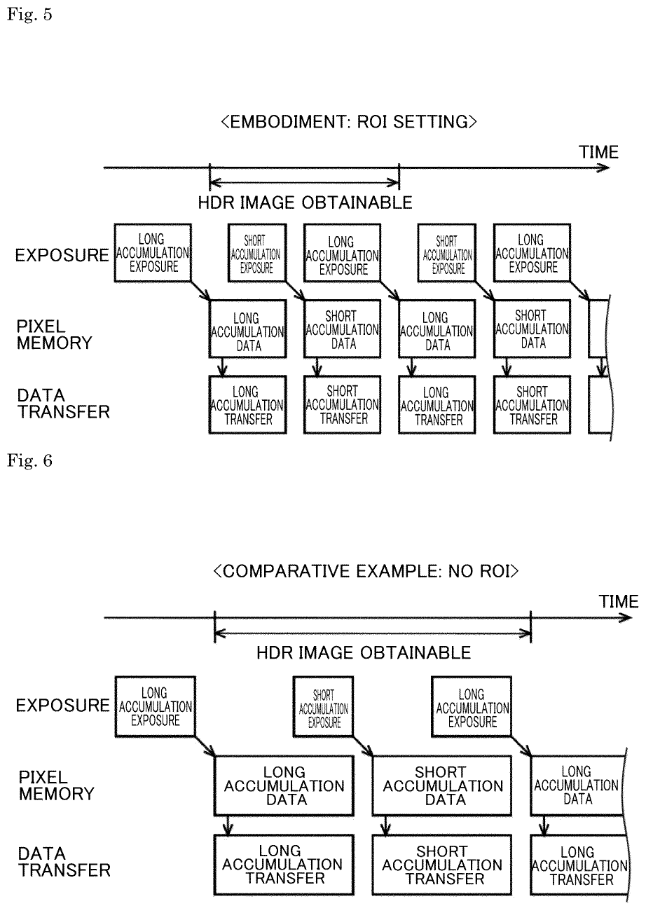

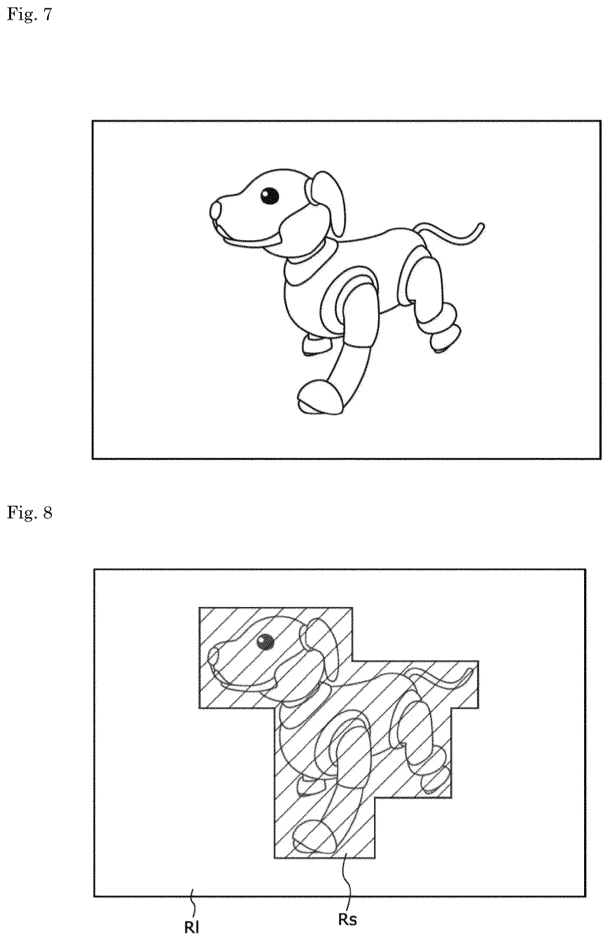

FIG. 6 is a diagram illustrating a timing chart in a state where an ROI is not set as a comparative example.

As illustrated in FIG. 5, in the present embodiment, by setting a given ROI in the image according to the configuration described above as a non-limiting example, the time for data transfer from the light-receiving elements in the global shutter is shortened, and an HDR image is generated efficiently.

Specifically, when an ROI is not set, as illustrated in FIG. 6, a long accumulation exposure is performed, after which the long accumulation data is output from the memory via the pixel circuitry such as the FD. The short accumulation exposure is started when the transfer from the memory to the FD in the light-receiving element is completed, and short accumulation data is accumulated in the memory. For both the short accumulation data and the long accumulation data, the final HDR image cannot be obtained until the transfer of all the pixels is completed. This makes it possible to obtain the HDR image at the timing at which the transfer of the two frames ends for all the pixels.

On the other hand, as illustrated in FIG. 5, setting the ROI makes it possible to shorten the time for data transfer to the time required to execute the transfer for the pixels belonging to the ROI. Accordingly, setting an ROI for the long accumulation and the short accumulation, respectively, makes it possible to shorten the time required for data transfer by at least about half.

Any method may be used to set the ROI. In an aspect in which an ADC is provided for each of regions, the ROI can be set for each of the regions, whereas in an aspect in which an ADC is provided for each of the pixels, the ROI can be set for any desired form.

As described thus far, according to the present embodiment, setting the ROI for executing long accumulation and short accumulation in the pixel array makes it possible to shorten the time for generating the HDR composite image and improve the framerate for image obtainment. Improving the framerate also suppresses the occurrence of motion blur and the like, which makes it possible to improve the accuracy of the HDR image itself.

The foregoing implementation will be described hereinafter using several specific examples.

### SECOND EMBODIMENT

FIG. 7 is a diagram illustrating an example of an object to be captured. A non-limiting example of setting an ROI for a case where a subject is present nearby, as illustrated in the drawing, will be described here. Although the following example will be described using several images, it should be noted that with respect to the ROI indicated in this image, the pixels in the pixel array are set as short accumulation pixels and long accumulation pixels, and processing based on the respective exposure times is executed within the semiconductor substrate described above. It should also be noted that the terms “image” and “light-receiving region” (“pixel array”), and “pixels within the image” and “light-receiving pixels”, can be interchanged as appropriate depending on the context.

FIG. 8 is a diagram illustrating an example of setting an ROI according to an embodiment. As illustrated in this drawing, the solid-state imaging device sets a short accumulation region Rs and a long accumulation region Rl.

The short accumulation region Rs is set as a region including the subject, for example. In FIG. 8, the region indicated by hatching is set as the short accumulation region Rs. The region outside this short accumulation region Rs is set as the long accumulation region Rl. By setting the ROI in this manner, the solid-state imaging device obtains short accumulation data in the short accumulation region Rs, and obtains long accumulation data in the long accumulation region Rl.

In the pixels belonging to the long accumulation region Rl, image capturing (light reception) is executed at a longer exposure time. In the pixels belonging to the short accumulation region Rs, image capturing (light reception) is executed at a shorter exposure time than in the long accumulation region Rl. The exposure time may be set to a degree such that each region is not saturated, taking into account the ISO sensitivity and the like, for example. The exposure time may also be set on the basis of a predetermined exposure time.

Setting the ROI as indicated in FIG. 8 makes it possible to perform a short exposure in the region where the subject is present such that the pixel values are not saturated, and to perform a long exposure in the region where the subject is not present such that light from far away can be obtained accurately.

The subject may be determined by referring to past frame images, or an LED or the like may be caused to emit light in advance, and the subject may be set according to the intensity of the reflected light received. As another example, a range image may be obtained and set using Time of Flight (ToF) or the like. This setting may be made in the same manner in other embodiments as well.

In addition, for example, the brightness at a close range in a dark place can be controlled by changing the brightness of an LED or the like provided in the solid-state imaging device. Furthermore, even if the subject or the like is in shadow due to backlighting or the like, the brightness thereof can to a certain extent be controlled by changing the brightness of the LED or the like. For backlighting, the region of the subject may be used as the long accumulation region, and the other regions may be used as the short accumulation region.

In this manner, the long accumulation region and the short accumulation region are not determined according to whether the subject is shown, but are rather set as appropriate in accordance with the scene. In addition, for example, when a light source or the like that is simply bright appears in the image instead of backlighting, the region of the light source and regions that strongly reflect the light from the light source may be set as the short accumulation region.

The determination of each region according to such scenes is the same in the following embodiments. For example, although the following embodiments will mainly describe cases where the subject is bright, the technique is not limited thereto, and the long accumulation region and the short accumulation region are set according to the scene as appropriate.

By obtaining the pixel values in the short accumulation region Rs and the long accumulation region RI as appropriate at timings such as those indicated in FIG. 5, an HDR composite image can be obtained without significantly reducing the framerate. The present embodiment can be implemented, for example, by using a semiconductor substrate including an ADC for each pixel. Although a region which is large relative to the subject is taken as the short accumulation region Rs in FIG. 8, in an aspect where an ADC is provided for each pixel, the ROI can be set at a finer level.

### THIRD EMBODIMENT

Although the foregoing has described that the ROI can be any shape according to the subject, the technique is not limited thereto. For example, if the semiconductor substrate includes an ADC for each region as described above, a single ROI may be applied for a single ADC.

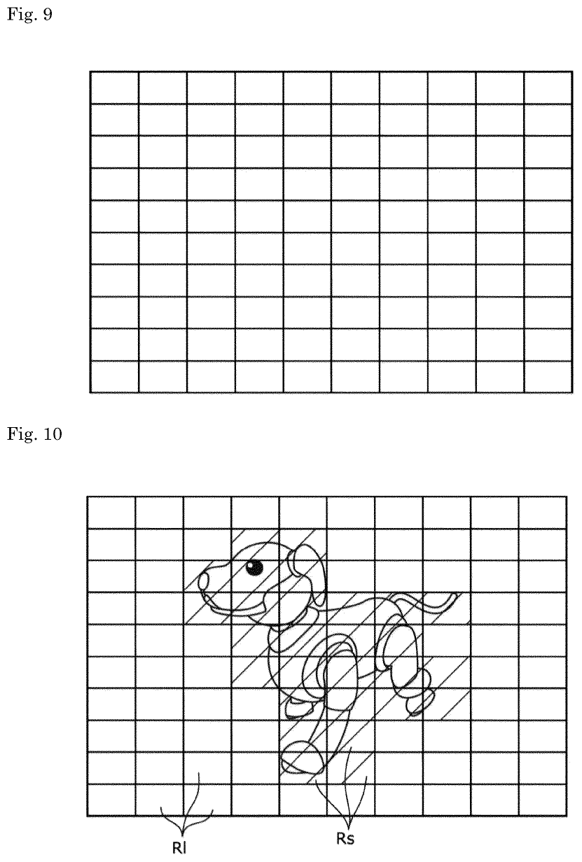

FIG. 9 is a diagram illustrating an example in which the unit at which the ROI is set is a single ADC. As illustrated in FIG. 9, an ROI setting range may be determined for each region in which the ADC is provided, for example.

In this aspect, the pixels which capture the image are divided into such predetermined regions, with each predetermined region being classified as a long accumulation region for long exposure and a short accumulation region for short exposure. The pixels belonging to the long accumulation regions and the pixels belonging to the short accumulation regions classified as such undergo different processing to execute the processing of intensity signals of the light received by the pixels.

FIG. 10 is a diagram illustrating an example of a case where the ROI setting method illustrated in FIG. 9 is applied to the image in FIG. 7. The regions indicated by the hatching are the short accumulation region Rs, and the long accumulation region Rl. As illustrated in this figure, the solid-state imaging device may set an ROI for each region corresponding to an ADC, and then set an exposure time for each ROI. Setting the ROI in this manner makes it possible to set the output timing for each region when an ADC is provided for each region, which in turn makes it possible to reduce the control signals for the output of the digital pixel data via the ADCs compared to a case where the ROI is set to a desired shape. This makes it possible to suppress power consumption and the like.

### FOURTH EMBODIMENT

Although the ROIs are classified into two regions, namely the short accumulation region Rs and the long accumulation region Rl, in the foregoing second and third embodiments, the technique is not limited thereto.

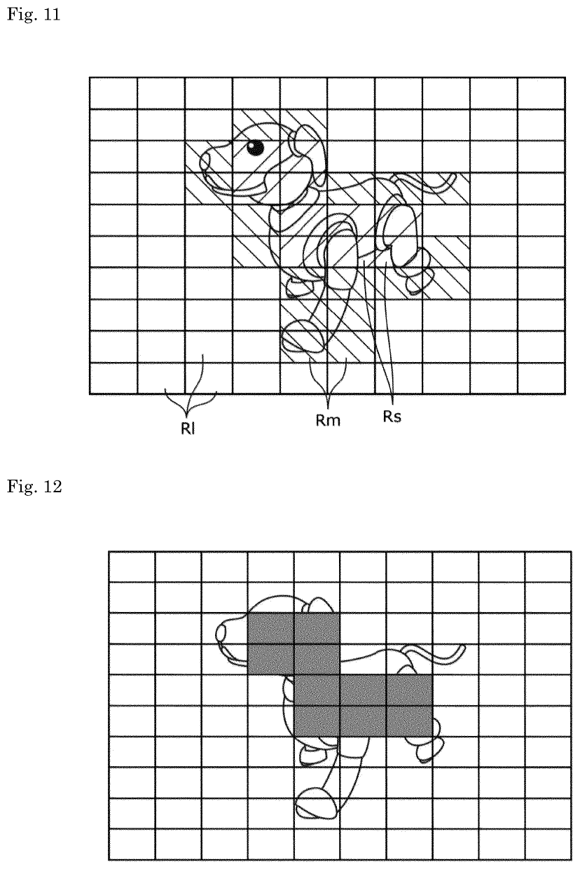

FIG. 11 is a diagram illustrating an example of an ROI according to an embodiment. As illustrated in FIG. 11, in addition to the long accumulation region Rl and the short accumulation region Rs indicated by the upper-right hatching, an intermediate accumulation region Rm, indicated by the upper-left hatching, may be provided as well. For example, light may be received in each of the regions and the pixel data may be obtained by setting the exposure time in each region to (exposure time at Rs)<(exposure time at Rm)<(exposure time at Rl).

These regions may be set, for example, as the long accumulation region RI when the subject is less than or equal to a first predetermined number; as the intermediate accumulation region Rm when the subject is higher than the first predetermined number and less than a second predetermined number; and as the short accumulation region Rs when the subject is at least the second predetermined number. As a specific non-limiting example, the first predetermined number may be 0 and the second predetermined number may be the number of pixels in the region, i.e., the region where the subject does not appear may be the long accumulation region Rl, the region where all the pixels in the region correspond to the subject may be the region Rs, and the other region may be Rm.

Although classification into two types, namely the long accumulation regions and short accumulation regions, will be described in other embodiments as well, the concept also includes classification into three or more types of regions, as in the present embodiment. In this case, as in the following fifth embodiment, there may be a region to which the exposure times of any two or more types of classifications are applied.

### FIFTH EMBODIMENT

As another example, both long accumulation and short accumulation may be executed for the region Rm. In other words, an image may be captured at both the long accumulation and short accumulation exposure times in the region indicated by the upper-left hatching in FIG. 11. In this case, data transfer for the region Rm is performed for both long accumulation and short accumulation, and the overall transfer time is therefore longer than in the aforementioned embodiments; however, HDR compositing for the region Rm can be implemented with a higher level of accuracy.

Long accumulation and short accumulation in the state illustrated in FIG. 11 will be described in further detail.

FIG. 12 is a diagram illustrating the long accumulation region in FIG. 11. As illustrated in FIG. 12, a region including a part of the subject and a region not including the subject are set as the long accumulation region, and a long accumulation image is obtained. The region indicated by gray in the figure is the region where the data is not obtained at the timing when the long accumulation data is obtained.

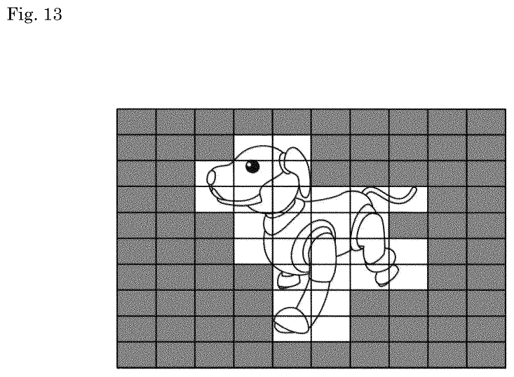

FIG. 13 is a diagram illustrating the short accumulation region in FIG. 11. As illustrated in FIG. 13, a region including a large part of the subject is set as the short accumulation region, and a short accumulation image is obtained. The region indicated by gray in the figure is the region where the data is not obtained at the timing when the short accumulation data is obtained.

In this manner, the long accumulation region and the short accumulation region may overlap. In other words, the long accumulation region and the short accumulation region may be set (classified) so as to overlap in any predetermined region.

### SIXTH EMBODIMENT

The long accumulation region and the short accumulation region have been described in the foregoing embodiments, and a more specific example of the setting of these regions will be described next.

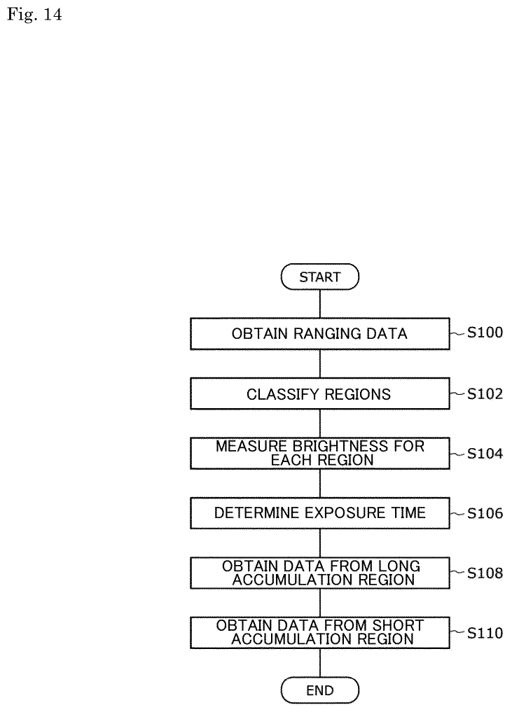

FIG. 14 is a flowchart illustrating processing performed by the solid-state imaging device according to an embodiment. Processing from image capture to data transfer will be described with reference to this flowchart.

First, the solid-state imaging device obtains ranging data (S100). This ranging may be executed by obtaining a TOF image or an image plane phase difference image, as will be described in detail later.

The solid-state imaging device then classifies the regions based on the ranging data (S102). There are three types of regions, e.g., a region in which the subject is not present, a region in which a part of the subject is present, and a region of the subject. For example, the region in which the subject is not present is classified as the region Rl, the region in which a part of the subject is present is classified as Rm, and the region in which only the subject is present is classified as the region Rs.

The solid-state imaging device then captures an image and measures the brightness for each region (S104). At the timing of imaging, light may be emitted by an LED or the like as appropriate. For example, brightness information is obtained for the region RI and the region Rs. The information is not needed for the region Rm. The processing of S100 to S104 may be executed in parallel depending on the configuration of the device.

The solid-state imaging device then determines exposure times based on the measured brightness (S106). For example, an exposure time at which the pixel values in the region Rl are not saturated and an exposure time in which the pixel values in the region Rs are not saturated are each set.

The solid-state imaging device then obtains the data of the long accumulation region (S108). For this data, captured image data is obtained at the exposure time for the region RI determined in S106, among the exposure times for the region Rl and the region Rm, and accumulation in the memory and data transfer are executed.

The solid-state imaging device then obtains the data of the short accumulation region (S110). For this data, captured image data is obtained at the exposure time for the region Rs determined in S106, among the exposure times for the region Rm and the region Rs, and accumulation in the memory and data transfer are executed. As illustrated in FIG. 5, these pieces of data can be obtained in parallel according to the timing of the transfer.

Note that the order of S108 and S110 may be switched. In addition, instead of measuring the distance for each frame, the distance may be measured every predetermined frame. Furthermore, the brightness for each region may be measured or the exposure time may be determined by comparing the image obtained in the previous frame with the ranging data in the current frame. Further still, the region of the current frame may be classified using the ranging data and the captured image data of the previous frame.

As described above, the ranging may be executed through the ToF method, or an image plane phase difference may be used. When using the ToF method, any method may be used, e.g., iToF (in-direct ToF) or dTof (direct TOF).

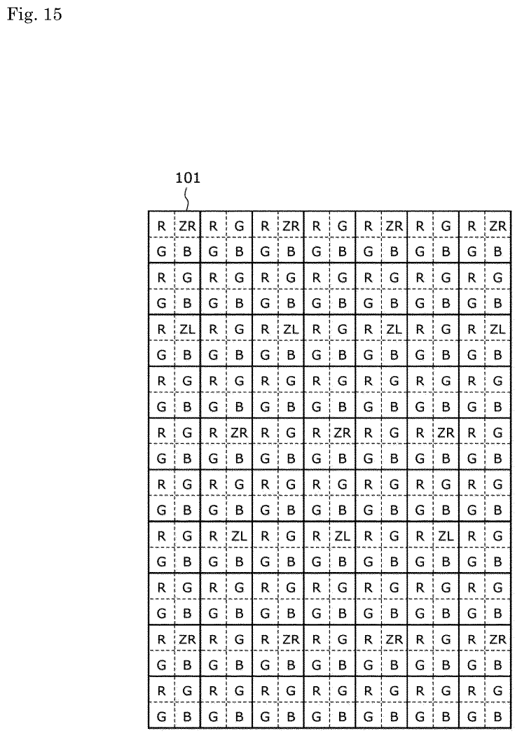

FIG. 15 is a diagram schematically illustrating an example of embedding image plane phase difference pixels according to an embodiment. For example, single pixels each including four sub-pixels may be disposed in an array in the pixel array. As illustrated in the drawing, four sub-pixels are provided for each pixel 101. The letters in the sub-pixels indicate elements that receive light, where R is red, G is green, and B is blue. These elements may be configured to obtain light of a corresponding color as appropriate by using, for example, a color filter, an organic photoelectric conversion film, or the like corresponding to each color.

ZR and ZL are sub-pixels for obtaining image plane phase differences. For example, ZR is a pixel having an aperture on the right side and ZL is a pixel having an aperture on the left side. The image plane phase difference between the pixels is obtained through the combination of ZR and ZL, and a distance is obtained from the image plane phase difference.

Note that FIG. 15 illustrates an example, and the configuration is not limited thereto. For example, instead of the three primary RGB colors, at least one of the three complementary colors (CyMgYe) may be included, and the configuration is not limited to combinations thereof. Furthermore, the positions of the sub-pixels from which the image plane phase difference is obtained are not limited to those described here, and may be arranged such that the range image can be obtained appropriately.

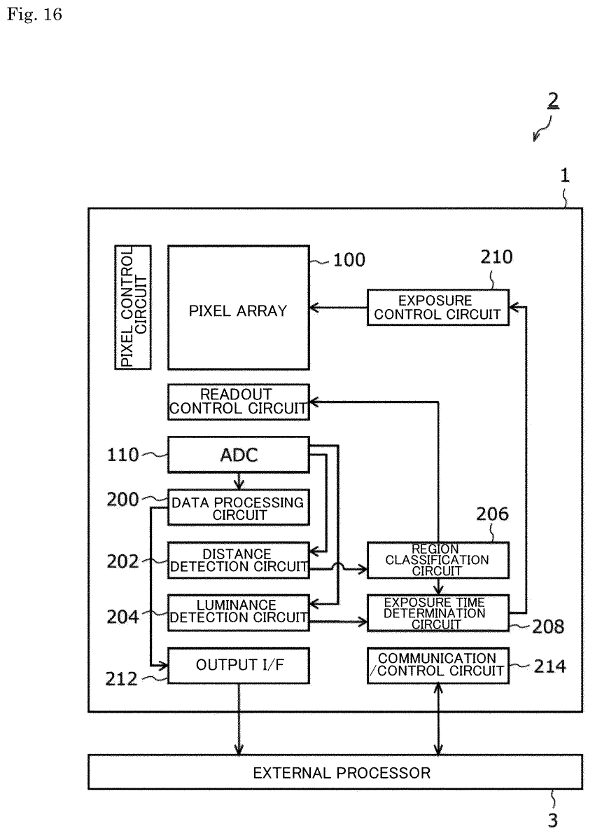

FIG. 16 is an implementation example illustrating an example of ranging using the image plane phase difference, according to an embodiment.

A solid-state imaging device 2 includes the semiconductor substrate 1 described above and an external processor 3. Although the semiconductor substrate 1 is illustrated as a single substrate, the semiconductor substrate 1 may be constituted by a plurality of substrates which are stacked, as described above.

The external processor 3 is a processor that appropriately processes information output from the semiconductor substrate 1, and implements overall processing and control of the solid-state imaging device 2 including the semiconductor substrate 1. Various types of data processed in the semiconductor substrate 1 may be processed, input, and output through the external processor 3.

The pixel array 100 is equivalent to the pixel array 100 described earlier, and is a region in which a plurality of pixels 101 are disposed in a two-dimensional array. Pixels for obtaining an image plane phase difference are included in the pixel array 100.

A pixel control circuit is, for example, a circuit that executes operations equivalent to those executed by the pixel driving circuit 102, the vertical scanning circuit 113, and the like described earlier.

A readout control circuit is, for example, a circuit corresponding to the output circuit 111 described earlier. For example, the timing of the data transfer from the pixel memory illustrated in FIG. 5 is controlled by the readout control circuit.

A data processing circuit 200 is a circuit that executes appropriate data processing on the signals output from each pixel via the ADCs 110, and outputs the processed signals.

A distance detection circuit 202 is a circuit that detects a distance based on the output of the ADCs 110. The distance is detected from the image plane phase difference.

A luminance detection circuit 204 is a circuit that detects the luminance of the pixels based on the output of the ADCs 110. The luminance detection circuit 204 detects the luminance for each pixel, for example, and outputs a luminance value for each region corresponding to the ADCs illustrated in FIG. 9. Of course, when ADCs are provided for each pixel, the luminance values for the pixels may be output directly. The luminance value output by the luminance detection circuit 204 may be, for example, a maximum value of the luminance for each region, or may be an appropriate statistical value such as an average value, a median, or the like. The luminance detection circuit 204 detects the luminance value required to determine the exposure time, and outputs this luminance value for each region. “Each region” may be, for example, the long accumulation region and the short accumulation region, or may be regions classified at a finer level.

A region classification circuit 206 is a circuit that classifies the long accumulation region and the short accumulation region based on the distance information output by the distance detection circuit 202. The classification method is as described above. If the distance detection circuit 202 is not provided, the region classification circuit 206 may determine the region based on the output from the luminance detection circuit 204, as another example of the configuration.

An exposure time determination circuit 208 determines the exposure times of the long accumulation region and the short accumulation region based on the regions classified by the region classification circuit 206 and the luminance values detected by the luminance detection circuit 204.

An exposure control circuit 210 controls the exposure times of the long accumulation region and the short accumulation region based on the exposure times determined by the exposure time determination circuit 208, and controls the light received by the pixel array 100.

The readout control circuit then controls the outputs from the respective pixels 101 of the pixel array 100 based on the regions classified by the region classification circuit 206, and controls the analog signals from the exposed pixels to be AD-converted in the ADCs 110 as appropriate.

Note that the distance detection circuit 202, the region classification circuit 206, and the like may be implemented in the external processor 3 instead of the semiconductor substrate 1. In this case, the information of the image plane phase difference pixels from the previous frame is normally output from the semiconductor substrate 1, and the region classification result may be set using a register or the like on the external processor 3 side.

An output I/F 212 is an interface that outputs image data processed by the data processing circuit 200 to the exterior as appropriate. The necessary data obtained through light reception in the semiconductor substrate 1 and subjected to data processing is output through this output I/F 212.

A communication/control circuit 214 is a circuit that executes communication between the semiconductor substrate 1 and the external processor 3, as well as overall control of the semiconductor substrate 1. On the basis of requests from the external processor 3, for example, the communication/control circuit 214 controls the appropriate constituent elements of the semiconductor substrate 1 to execute appropriate processing.

In the above, each constituent element is described as a circuit, but the elements may actually be implemented by a processor which is hardware that performs the information processing by software. In this case, the software-related programs, executable files, and the like may be stored in a storage unit (not shown) in the semiconductor substrate 1 or in the external processor 3.

When ToF is used, the distance detection circuit 202 in FIG. 16 is not provided in the semiconductor substrate 1, and a ToF substrate may be provided as a chip separate from the semiconductor substrate 1. In this case, appropriate distance information is obtained from the ToF substrate, and the region classification circuit 206 executes the region classification, for example.

The configuration may be such that the region classification circuit 206 is provided on the ToF substrate side. In the case of such a configuration, exposure control and readout control are executed by communicating the information of the classified regions from the ToF substrate.

When performing ranging through ToF in such a manner, the regions can be classified without using the luminance information obtained by the pixel array, and thus as described above, the processing of S100 and S102 can be executed in parallel with the processing of S104 in FIG. 14.

As described above, according to the present embodiment, obtaining the range image separately from the luminance makes it possible to classify the long accumulation region and the short accumulation region based on the distance. Using the distance information makes it possible to capture the subject as appropriate, which in turn makes it possible to implement HDR compositing for the subject and the background, respectively, as appropriate.

Note that the HDR compositing may be executed by the data processing circuit 200 based on the information output from the ADCs 110, or may be executed by the external processor 3. A variety of methods can be used for the HDR compositing as desired.

### SEVENTH EMBODIMENT

Although the sixth embodiment described executing the classification of the regions using a range image, the configuration is not limited thereto. The solid-state imaging device can also classify the regions without obtaining a range image. For example, the regions may be classified by using the luminance values in individual predetermined regions indicated by the grid in FIG. 9.

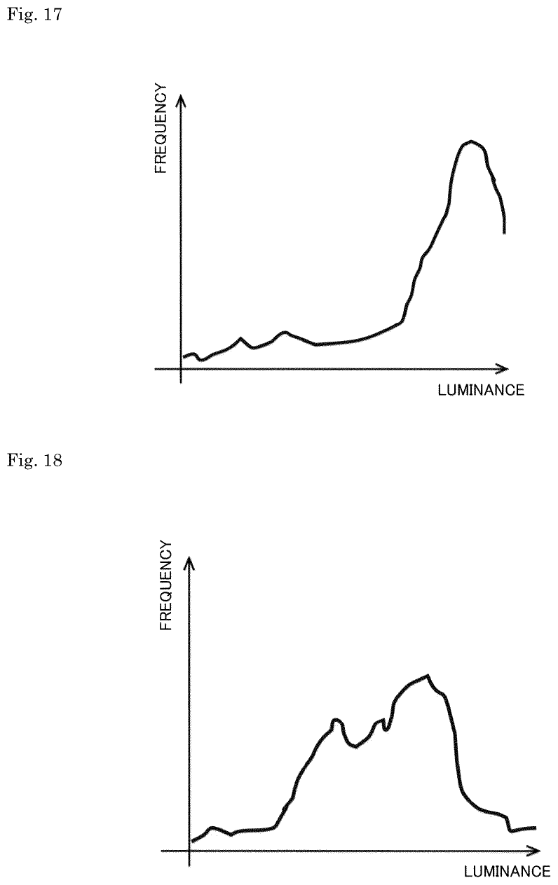

FIGS. 17, 18, and 19 are diagrams illustrating an example of histograms in the luminance values in respective regions.

In FIG. 17, high luminance values, i.e., bright pixels, are concentrated within the region, and the region as a whole is saturated. The solid-state imaging device may classify such a region as a short accumulation region in which the exposure time is shortened such that the pixel values do not saturate.

On the other hand, in FIG. 18, the luminance values are not particularly saturated. Because the pixel values are not saturated, the solid-state imaging device may classify such a region as a long accumulation region in which the exposure time is lengthened.

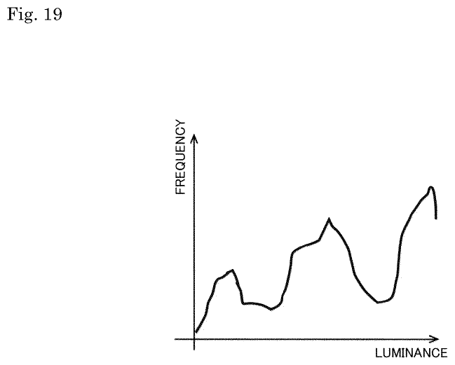

If there are many pixels where saturation is apparent but the histogram is high in parts outside parts where the luminance values are high, as indicated in FIG. 19, the regions may be classified for obtaining data both at a short exposure time and a long exposure time.

These classifications may be determined, for example, using appropriate statistical values. For example, in a case such as that illustrated in FIG. 17, the classification may be determined on the basis of the average of the luminance values in the region being higher than a predetermined value and the distribution being lower than a predetermined value. Similarly, in FIG. 18, the classification may be determined on the basis of the average of the luminance values being lower than a predetermined value and the distribution being higher than a predetermined value. In FIG. 19, the classification may be determined on the basis of the average of the luminance values being higher than a predetermined value and the distribution being higher than a predetermined value. Of course, another determination method may be used, and the determination may be made using appropriate statistical values.

As another example, these determinations may be made using a neural network model trained in advance through machine learning. In this case, the determination processing using the neural network model may be executed in the semiconductor substrate 1.

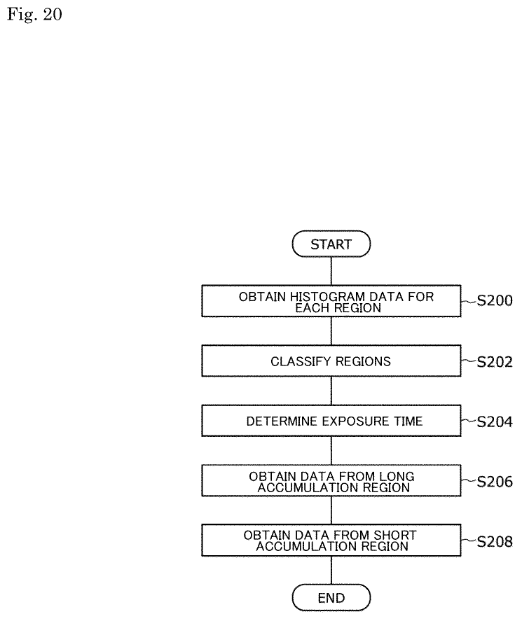

FIG. 20 is a flowchart illustrating processing performed by the solid-state imaging device according to an embodiment.

The solid-state imaging device obtains histogram data for each region (S200). The histograms may be obtained through any method.

Next, the solid-state imaging device classifies the regions based on the information of the histograms (S202).

The solid-state imaging device then determines the exposure times of the long accumulation region and the short accumulation region based on the information of the classified regions and the information of the histograms of the classified regions (S204).

Next, the solid-state imaging device executes the data obtainment for the long accumulation region (S206) and the data obtainment for the short accumulation region (S208), respectively, in the same manner as the flowchart illustrated in FIG. 14, as appropriate. As described with reference to FIG. 14 as well, the orders thereof may be changed, the classification of the regions may be executed every predetermined frame rather than for each frame, or the classification may be executed on the basis of the light reception state in a past frame.

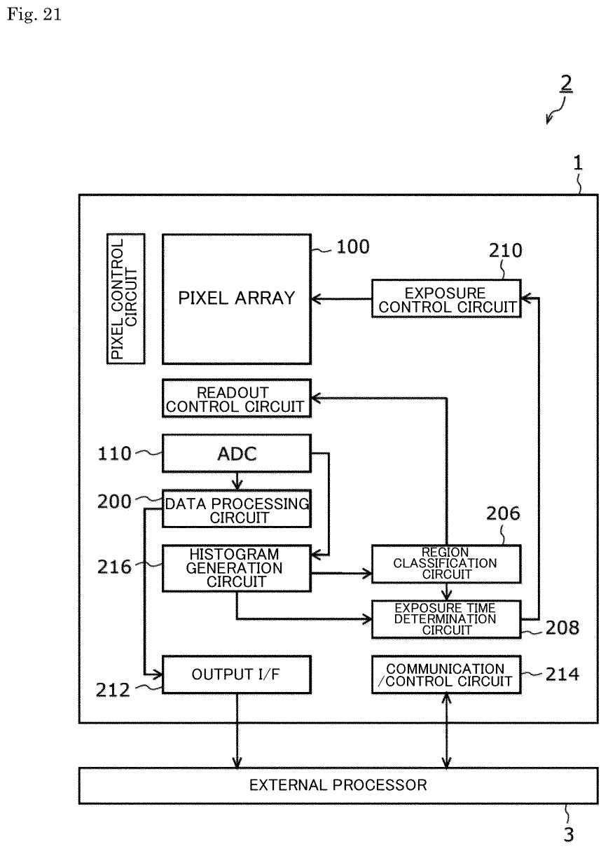

FIG. 21 is a block diagram schematically illustrating an example of the solid-state imaging device according to an embodiment. Unless otherwise specified, constituent elements assigned the same reference signs as in FIG. 16 execute the same processing. The semiconductor substrate 1 of the solid-state imaging device 2 includes a histogram generation circuit 216.

The histogram generation circuit 216 generates histograms for each predetermined region based on the pixel values output from the ADCs 110. The histograms may be generated through any method.

The region classification circuit 206 classifies the respective regions as long accumulation regions, short accumulation regions, or both based on the generated histograms.

The exposure time determination circuit 208 determines the exposure times based on the information of the regions classified by the region classification circuit 206 and the histogram information generated by the histogram generation circuit 216.

As described above, according to the present embodiment, an exposure time for each region can be determined on the basis of a histogram of pixel values in each predetermined region, without using a distance image. This makes it possible to execute the compositing of the HDR image as appropriate, regardless of the subject, even when there are pixels that saturate due to the presence of a local light source, a reflective object, or the like, for example.

### EIGHTH EMBODIMENT

Although the foregoing embodiments described HDR compositing using visible light, the configuration is not limited thereto, and for example, HDR compositing using infrared light can be performed as well. For example, in an in-vehicle camera, high-precision HDR compositing can be executed on a bright day by obtaining a range image or taking into account saturated pixels, as in the foregoing embodiments. On the other hand, in nighttime road conditions, it may be possible to perform HDR compositing as appropriate up to a certain distance where the headlights reach, but not to far areas where the light from the vehicle lights does not reach. Infrared light may be used to handle such cases.

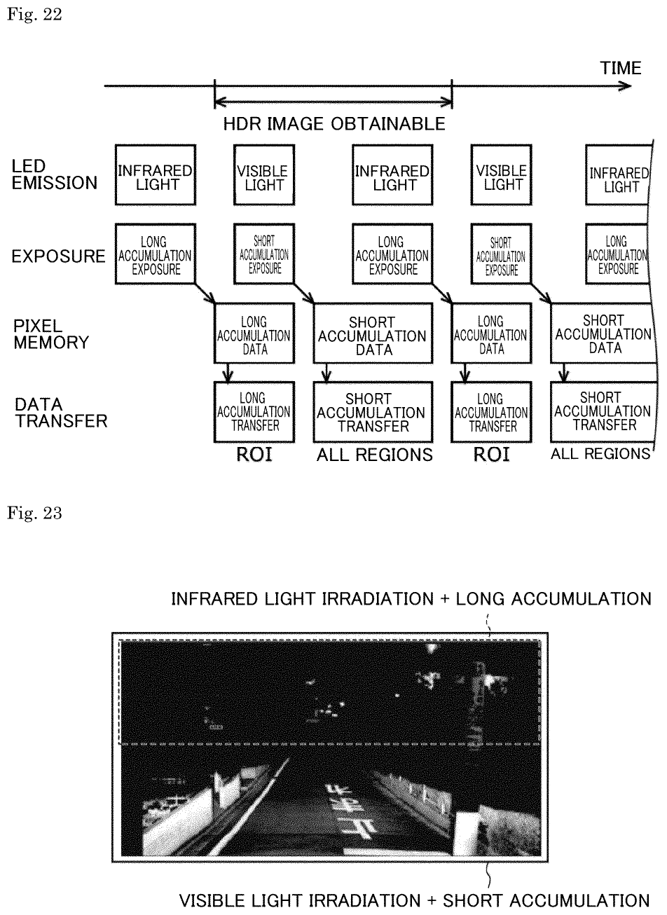

FIG. 22 is a diagram conceptually illustrating the timing of data obtainment according to the present embodiment. The solid-state imaging device emits light from an LED and executes exposure. The emission of light from the LED may be performed from another illumination device, rather than from the solid-state imaging device. The configuration may be such that light from another illumination device is used for visible light in particular, whereas the LED of the solid-state imaging device is used when using infrared light.

In this case, pixels capable of receiving infrared light are disposed in the pixels 101 provided in the pixel array 100. The arrangement may be any arrangement as long as infrared light can be received and an image can be formed as appropriate.

The solid-state imaging device emits infrared light from the LED, and lengthens the exposure time to obtain long accumulation data in pixels which belong to the long accumulation region and which can receive infrared light. The processing for transferring this data is executed, and then, while emitting visible light, the solid-state imaging device shortens the exposure time and obtains the short accumulation data in the short accumulation region.

The long accumulation region and the short accumulation region may be classified as described in the foregoing embodiments.

As another example, the long accumulation region may be designated as the ROI, while the short accumulation region may be designated as the overall region of the pixels. In other words, the solid-state imaging device shortens the exposure time for obtaining visible light, and obtains an image using this visible light for all the pixels. On the other hand, the exposure time for obtaining infrared light is set to be long, and an image is obtained using this infrared light in the region classified as a long accumulation region.

By obtaining the data in this manner, information from all pixels is obtained for visible light, and information from the ROI is obtained for infrared light.

FIG. 23 is a diagram illustrating an example of setting an ROI on a road at night. As illustrated in this figure, reflected light and scattered light produced by visible light can be obtained by the image sensor at relatively close distances, and thus the information can be obtained as an accurate image. On the other hand, reflected light and scattered light produced by distant visible light are difficult to obtain, and thus an accurate image cannot be obtained as information.

In such a distant region, using infrared light increases the likelihood of being able to obtain an image. Accordingly, the distant part of the road is irradiated with infrared light, the region in the pixel array corresponding to the distant region is classified as the long accumulation region, a long exposure is performed in this region, and the infrared light is received.

Using such light-receiving timing makes it possible to both improve the framerate limited by the transfer, as in the foregoing embodiments, and obtain information at a distance as appropriate by using infrared light. In distant parts, information on short accumulations using visible light and information on long accumulations using infrared light can be used to obtain an HDR composite image.

As described thus far, according to the present embodiment, for example, an HDR composite image can be obtained without reducing the framerate as appropriate, even in dark places such as images obtained by an in-vehicle camera at night.

For example, in an image capturing device such as an in-vehicle camera, it may be appropriate to have a configuration that uses an infrared cutting film for pixels as appropriate during the day. When an infrared cutting film is used in this manner, the infrared cutting film may be equipped at an appropriate location of the solid-state imaging device during the day, for example, but not equipped at night.

In addition to applications such as in-vehicle cameras, infrared images can also be used effectively in shooting dark places, e.g., in surveillance cameras and fixed-point cameras.

The application of the semiconductor substrate 1 in the foregoing embodiments will be described hereinafter using several non-limiting examples.

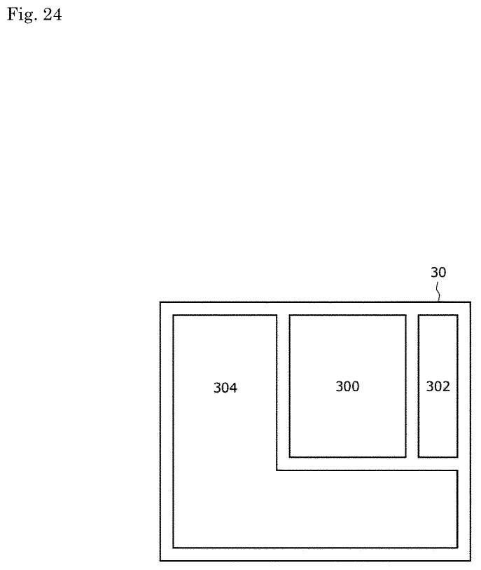

FIG. 24 is a diagram illustrating an example of a substrate provided in the solid-state imaging device 2. A substrate 30 includes a pixel region 300, a control circuit 302, and a logic circuit 304. As illustrated in FIG. 24, the pixel region 300, the control circuit 302, and the logic circuit 304 may be provided on the same substrate 30.

The pixel region 300 is, for example, a region in which the pixel array 100 and the like described above are provided. The pixel circuit and the like described above may be provided in this pixel region 300 or may be provided in another region (not shown) of the substrate 30 as appropriate. The control circuit 302 includes a control unit. The logic circuit 304, e.g., the ADC and the like according to the embodiments, may be provided in the pixel region 300 and may output the converted digital signal to the logic circuit 304. Other signal processing circuits, such as the data processing circuit 200, may also be provided in the logic circuit 304. At least part of the signal processing circuit may be mounted on another signal processing chip provided at a different location from the substrate 30, or may be mounted in another processor, e.g., the external processor 3.

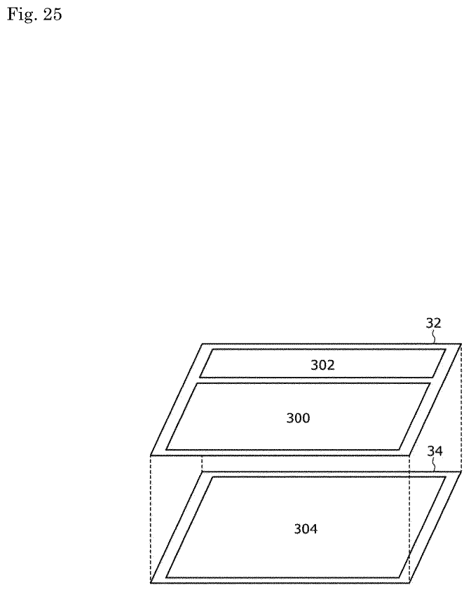

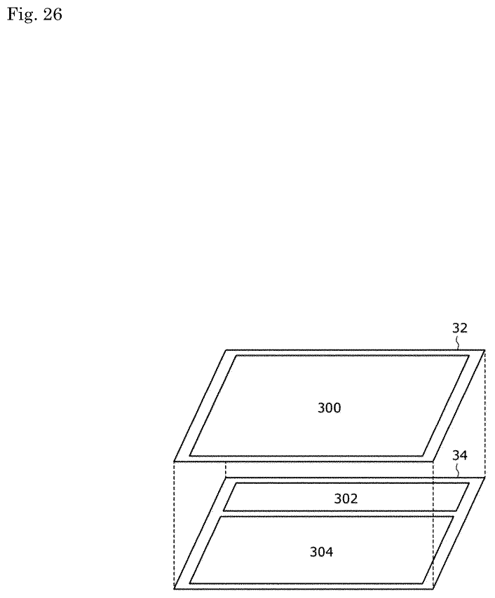

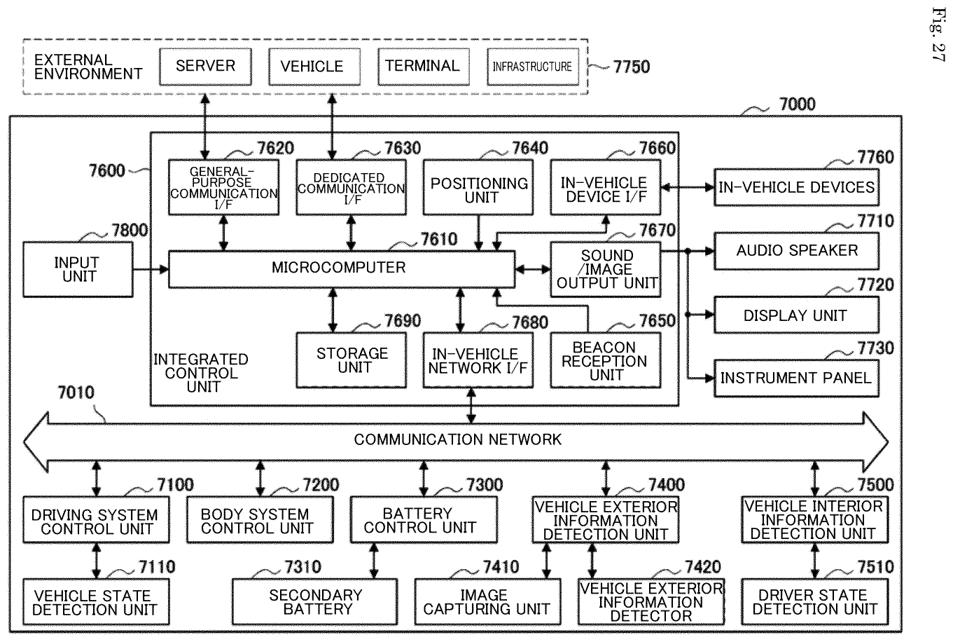

FIG. 25 is a diagram illustrating another example of a substrate provided in the solid-state imaging device 2. A first substrate 32 and a second substrate 34 are provided as substrates. The first substrate 32 and the second substrate 34 have a stacked structure in which signals can be transmitted and received as appropriate via a connecting part, e.g., a via hole. For example, the first substrate 32 may include the pixel region 300 and the peripheral circuitry thereof, and the second substrate 34 may include the other signal processing circuitry. The first substrate 32 may correspond to the first substrate 10 described above, and the second substrate 34 may correspond to the second substrate 11 described above, for example. The same applies to FIG. 26.

FIG. 26 is a diagram illustrating another example of a substrate provided in the solid-state imaging device 2. The first substrate 32 and the second substrate 34 are provided as substrates. The first substrate 32 and the second substrate 34 have a stacked structure in which signals can be transmitted and received as appropriate via a connecting part, e.g., a via hole. For example, the first substrate 32 may include the pixel region 300, and the second substrate 34 may include the control circuit 302 and the logic circuit 304.

In FIGS. 24 to 26, a storage region may be provided in any region. In addition to these substrates, a substrate for the storage region may be provided between the first substrate 32 and the second substrate 34, or under the second substrate 34.

The stacked substrates may be connected via a via hole as described above or may be connected by a method such as micro dump. The substrates can be stacked by any method, such as Chip on Chip (CoC), Chip on Wafer (CoW), or Wafer on Wafer (WoW).

Note that the above-described solid-state imaging device may be implemented as a semiconductor chip including the functionality of at least part of the solid-state imaging device, e.g., an image sensor in the solid-state imaging device. In addition, although the present disclosure describes a form which uses a global shutter, the global shutter may be implemented by any circuit or light-receiving element.

The technique according to the present disclosure can be applied in various products. For example, the technique according to the present disclosure may be realized as a device mounted on any type of moving body such as an automobile, an electric automobile, a hybrid electric automobile, a motorcycle, a bicycle, a personal mobility device, an airplane, a drone, a ship, a robot, construction equipment, agricultural equipment (a tractor), or the like.

FIG. 27 is a block diagram schematically illustrating an example of the configuration example of a vehicle control system 7000, which is an example of a moving body control system to which the technique according to the present disclosure can be applied. The vehicle control system 7000 includes a plurality of electronic control units connected via a communication network 7010. In the example illustrated in FIG. 27, the vehicle control system 7000 includes a driving system control unit 7100, a body system control unit 7200, a battery control unit 7300, a vehicle exterior information detection unit 7400, a vehicle interior information detection unit 7500, and an integrated control unit 7600. The communication network 7010 connecting the plurality of control units may be, for example, an in-vehicle communication network compliant with any standard such as Controller Area Network (CAN), Local Interconnect Network (LIN), Local Area Network (LAN), and FlexRay (registered trademark).

Each control unit includes a microcomputer that performs arithmetic processing according to various programs, a storage unit that stores programs executed by the microcomputer, parameters used for various arithmetic operations, and the like, and a drive circuit that drives various control target devices. Each control unit includes a network I/F for performing communication with other control units via the communication network 7010, and includes a communication I/F for performing communication through wired communication or wireless communication with devices, sensors, or the like inside or outside of the vehicle. In FIG. 27, a microcomputer 7610, a general-purpose communication I/F 7620, a dedicated communication I/F 7630, a positioning unit 7640, a beacon reception unit 7650, an in-vehicle device I/F 7660, an sound/image output unit 7670, an in-vehicle network I/F 7680, and a storage unit 7690 are illustrated as functional configurations of the integrated control unit 7600. The other control units also include a microcomputer, a communication I/F, a storage unit, and the like.

The driving system control unit 7100 controls the operations of devices related to the driving system of the vehicle according to various programs. For example, the driving system control unit 7100 functions as a control device for a driving force generation device for generating vehicle driving force, such as an internal combustion engine or a drive motor, a driving force transmission mechanism for transmitting the driving force to wheels, a steering mechanism for adjusting a steering angle of the vehicle, and a braking device that generates a braking force of the vehicle. The driving system control unit 7100 may have a function as a control device, for example, an Antilock Brake System (ABS) or Electronic Stability Control (ESC).

A vehicle state detection unit 7110 is connected to the driving system control unit 7100. The vehicle state detection unit 7110 includes, for example, at least one of a gyrosensor that detects an angular velocity of an axial rotation motion of the vehicle body, an accelerometer that detects an acceleration of the vehicle, and sensors for detecting an amount of operation with respect to an accelerator pedal, an amount of operation with respect to a brake pedal, a steering angle of a steering wheel, an engine speed, a rotation speed of wheels, and the like. The driving system control unit 7100 performs arithmetic processing using signals input from the vehicle state detection unit 7110 to control an internal combustion engine, a drive motor, an electric power steering device, a brake device, and the like.

The body system control unit 7200 controls operations of various devices provided in the vehicle body in accordance with various programs. For example, the body system control unit 7200 functions as control devices for a keyless entry system, a smart key system, power window devices, or various lamps such as headlights, backup lights, brake lights, turn signals, fog lights, and the like. In this case, radio waves emitted from a portable device that substitutes for a key or signals from various switches can be input to the body system control unit 7200. The body system control unit 7200 receives the input of the radio waves or signals and controls door lock devices, power window devices, the lamps, and the like of the vehicle.

The battery control unit 7300 controls a secondary battery 7310 which is a power supply source of a drive motor in accordance with various programs. For example, information such as a battery temperature, a battery output voltage, or a remaining capacity of a battery is input from a battery device including the secondary battery 7310 to the battery control unit 7300. The battery control unit 7300 performs arithmetic processing using such signals and performs temperature adjustment control of the secondary battery 7310 or control of a cooling device provided in the battery device.

The vehicle exterior information detection unit 7400 detects information on the exterior of the vehicle in which the vehicle control system 7000 is installed. For example, at least one of an image capturing unit 7410 and a vehicle exterior information detector 7420 is connected to the vehicle exterior information detection unit 7400. The image capturing unit 7410 includes at least one of a TOF (Time Of Flight) camera, a stereo camera, a monocular camera, an infrared camera, or another camera. The vehicle exterior information detector 7420 includes at least one of, for example, an environmental sensor for detecting the current weather or atmospheric conditions and a surrounding information detection sensor for detecting other vehicles, obstacles, or pedestrians or the like around the vehicle in which the vehicle control system 7000 is mounted.

The environmental sensor may be, for example, at least one of a raindrop sensor that detects rainy weather, a fog sensor that detects fog, a sunshine sensor that detects the degree of sunshine, and a snow sensor that detects snowfall. The surrounding information detection sensor may be at least one of an ultrasonic sensor, a radar device, and a Light Detection and Ranging or Laser Imaging Detection and Ranging (LIDAR) device. The image capturing unit 7410 and the vehicle exterior information detector 7420 may be provided as independent sensors or devices or may be provided as a device in which a plurality of sensors or devices are integrated.

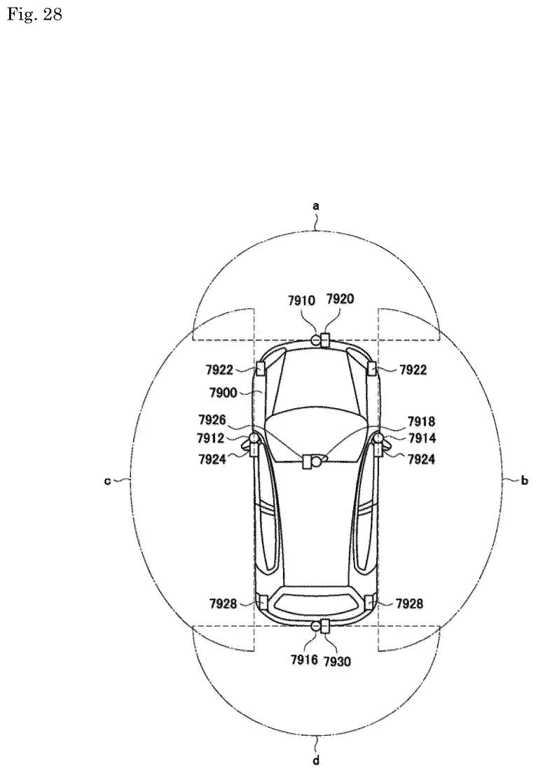

Here, FIG. 28 illustrates an example of installation positions of the image capturing unit 7410 and the vehicle exterior information detector 7420. Image capturing units 7910, 7912, 7914, 7916, and 7918 are provided, for example, at least one of a front nose, side mirrors, a rear bumper, a back door, and an upper part of a windshield in a vehicle cabin of a vehicle 7900. The image capturing unit 7910 provided in the front nose and the image capturing unit 7918 provided in the upper part of the windshield in the vehicle cabin mainly obtain images of the area in front of the vehicle 7900. The image capturing units 7912 and 7914 included in the side mirrors mainly obtain images of the sides of the vehicle 7900. The image capturing unit 7916 included in the rear bumper or the back door mainly obtains an image of the area to the rear of the vehicle 7900. The image capturing unit 7918 included in the upper part of the windshield in the vehicle cabin is mainly used to detect preceding vehicles, pedestrians, obstacles, traffic signals, traffic signs, lanes, or the like.

FIG. 28 illustrates an example of image capturing ranges of the image capturing units 7910, 7912, 7914, and 7916, respectively. An image capturing range a indicates an image capturing range of the image capturing unit 7910 provided in the front nose; image capturing ranges b and c indicate image capturing ranges of the image capturing units 7912 and 7914 provided on the side mirrors; and an image capturing range d indicates an image capturing range of the image capturing unit 7916 provided on the rear bumper or the back door. For example, by superimposing image data captured by the image capturing units 7910, 7912, 7914, and 7916, it is possible to obtain a bird's-eye view image seen from above the vehicle 7900.

Vehicle exterior information detectors 7920, 7922, 7924, 7926, 7928, and 7930 provided in a front, a rear, a side, a corner, and an upper part of the windshield in the vehicle cabin of the vehicle 7900 may be, for example, ultrasonic sensors or radar devices. The vehicle exterior information detectors 7920, 7926, and 7930 provided at the front nose, the rear bumper, the back door, and the upper part of the windshield in the vehicle cabin of the vehicle 7900 may be, for example, LIDAR devices. These vehicle exterior information detectors 7920 to 7930 are mainly used to detect preceding vehicles, pedestrians, obstacles, or the like.

The descriptions will be continued with reference to FIG. 27 again. The vehicle exterior information detection unit 7400 causes the image capturing unit 7410 to capture an image of the exterior of the vehicle, and receives the captured image data. Further, the vehicle exterior information detection unit 7400 receives detection information from the connected vehicle exterior information detector 7420. When the vehicle exterior information detector 7420 is an ultrasonic sensor, a radar device, or a LIDAR device, the vehicle exterior information detection unit 7400 transmits ultrasonic waves, electromagnetic waves, or the like, and receives information on received reflected waves. The vehicle exterior information detection unit 7400 may perform object detection processing or distance detection processing for peoples, cars, obstacles, signs, letters on the road, and the like based on the received information. The vehicle exterior information detection unit 7400 may perform environment recognition processing for recognizing rainfall, fog, road surface conditions, or the like on the basis of the received information. The vehicle exterior information detection unit 7400 may calculate the distance to an object outside of the vehicle on the basis of the received information.

The vehicle exterior information detection unit 7400 may also perform image recognition processing or distance detection processing for recognizing people, vehicles, obstacles, signs, text on the road surface, or the like on the basis of the received image data. The vehicle exterior information detection unit 7400 may perform processing such as distortion correction or alignment on the received image data, and combine image data captured by the different image capturing units 7410 to generate a bird's-eye view image or a panoramic image. The vehicle exterior information detection unit 7400 may perform viewpoint conversion processing using the image data captured by the different image capturing units 7410.

The vehicle interior information detection unit 7500 detects information on the interior of the vehicle. For example, a driver state detection unit 7510 that detects a state of a driver is connected to the vehicle interior information detection unit 7500. The driver state detection unit 7510 may include a camera that captures an image of the driver, a biometric sensor that detects biometric information of the driver, or a microphone that collects sounds from the vehicle cabin. The biometric sensor is provided on, for example, a seat surface, a steering wheel, or the like and detects biometric information of an occupant sitting on the seat or the driver holding the steering wheel. The vehicle interior information detection unit 7500 may calculate the level of the driver's fatigue or concentration, or may determine whether the driver is dozing, based on detection information input from the driver state detection unit 7510. The vehicle interior information detection unit 7500 may perform noise cancellation processing or the like on collected sound signals.

The integrated control unit 7600 controls overall operations in the vehicle control system 7000 according to various programs. An input unit 7800 is connected to the integrated control unit 7600. The input unit 7800 is implemented by a device that can be operated for input by an occupant, e.g., a touch panel, a button, a microphone, a switch, a lever, or the like. Data obtained through voice recognition of voice input through a microphone may be input to the integrated control unit 7600. The input unit 7800 may be, for example, a remote control device using infrared rays or other radio waves, or may be an externally-connected device such as a mobile phone or a Personal Digital Assistant (PDA) that supports operations on the vehicle control system 7000. The input unit 7800 may be, for example, a camera, in which case an occupant can input information using gestures. Alternatively, data obtained by detecting the motion of a wearable device worn by the occupant may be input. Further, the input unit 7800 may include, for example, an input control circuit that generates an input signal on the basis of information input by the occupant or the like using the input unit 7800 and outputs the input signal to the integrated control unit 7600. The occupant or the like inputs various types of data to the vehicle control system 7000 or instructs processing operations by operating the input unit 7800.

The storage unit 7690 may include a Read Only Memory (ROM) that stores various programs to be executed by a microcomputer, and a Random Access Memory (RAM) that stores various parameters, calculation results, or sensor values or the like. The storage unit 7690 may be implemented by, for example, a magnetic storage device such as a Hard Disc Drive (HDD), a semiconductor storage device, an optical storage device, or a magneto-optical storage device.

The general-purpose communication I/F 7620 is a general-purpose communication I/F that mediates communication with various devices present in an external environment 7750. The general-purpose communication I/F 7620 may have, implemented therein, a cellular communication protocol such as Global System of Mobile communications (GSM) (registered trademark), WiMAX (registered trademark), Long Term Evolution (LTE) (registered trademark), or LTE-Advanced (LTE-A), or other wireless communication protocols such as wireless LAN (also referred to as Wi-Fi (registered trademark)) or Bluetooth (registered trademark). The general-purpose communication I/F 7620 may be connected to, for example, a device (for example, an application server or a control server) present on an external network (for example, the Internet, a cloud network, or a business-specific network) via a base station or an access point. The general-purpose communication I/F 7620 may be connected to terminals (for example, the terminals of the driver, pedestrians, or shops, or Machine Type Communication (MTC) terminals) near the vehicle by using, for example, Peer To Peer (P2P) technology.

The dedicated communication I/F 7630 is a communication I/F supporting a communication protocol formulated for the purpose of use in a vehicle. The dedicated communication I/F 7630 may implement, for example, a standard protocol such as Wireless Access in Vehicle Environment (WAVE) that is a combination of IEEE 802.11p in a lower layer and IE287609 in an upper layer, Dedicated Short Range Communications (DSRC), or a cellular communication protocol. The dedicated communication I/F 7630 typically performs V2X communications as a concept including one or more of vehicle to vehicle communications, vehicle to infrastructure communications, vehicle to home communications, and vehicle to pedestrian communications.

The positioning unit 7640 receives, for example, a GNSS signal from a global navigation satellite system (GNSS) satellite (for example, a GPS signal from a global positioning system (GPS) satellite), executes positioning, and generates position information including a latitude, longitude, and altitude of the vehicle. The positioning unit 7640 may specify a current position by exchanging signals with a wireless access point, or may obtain position information from a terminal such as a mobile phone, PHS, or smartphone having a positioning function.

The beacon reception unit 7650 receives radio waves or electromagnetic waves transmitted from a radio station or the like installed on a road, and obtains information such as a current position, traffic, closed roads, or required time. The functions of the beacon reception unit 7650 may be included in the above-described dedicated communication I/F 7630.

The in-vehicle device I/F 7660 is a communication interface that mediates connections between the microcomputer 7610 and various in-vehicle devices 7760 present in the vehicle. The in-vehicle device I/F 7660 may establish a wireless connection using wireless communication protocols such as a wireless LAN, Bluetooth (registered trademark), Near Field Communication (NFC), and Wireless USB (WUSB). Furthermore, the in-vehicle device I/F 7660 may establish a wired connection such as, for example, Universal Serial Bus (USB), High-Definition Multimedia Interface (HDMI) (registered trademark), or Mobile High-definition Link (MHL) via a connection terminal (not illustrated) (and a cable if necessary). The in-vehicle devices 7760 may include, for example, at least one of a mobile device or wearable device of an occupant and an information device carried in or attached to the vehicle. Further, the in-vehicle devices 7760 may include a navigation device that searches for a route to a desired destination. The in-vehicle device I/F 7660 exchanges control signals or data signals with the in-vehicle devices 7760.

The in-vehicle network I/F 7680 is an interface that mediates communication between the microcomputer 7610 and the communication network 7010. The in-vehicle network I/F 7680 transmits and receives signals or the like according to a predetermined protocol supported by the communication network 7010.

The microcomputer 7610 of the integrated control unit 7600 controls the vehicle control system 7000 in accordance with various programs based on information obtained through at least one of the general-purpose communication I/F 7620, the dedicated communication I/F 7630, the positioning unit 7640, the beacon reception unit 7650, the in-vehicle device I/F 7660, and the in-vehicle network I/F 7680. For example, the microcomputer 7610 may calculate control target values for a driving force generation device, a steering mechanism, or a braking device based on obtained information on the inside and outside of the vehicle, and output control commands to the driving system control unit 7100. For example, the microcomputer 7610 can perform coordinated control for the purpose of implementing functions of an advanced driver assistance system (ADAS) including vehicle collision avoidance, impact mitigation, following traveling based on an inter-vehicle distance, constant vehicle speed driving, vehicle collision warnings, and lane departure warning. Further, the microcomputer 7610 can perform coordinated control for the purpose of automated driving or the like in which autonomous travel is performed without requiring operations of the driver, by controlling the driving force generation device, the steering mechanism, the braking device, or the like based on obtained information about the surroundings of the vehicle.

The microcomputer 7610 may generate three-dimensional distance information between the vehicle and objects such as surrounding structures or people based on information obtained via at least one of the general-purpose communication I/F 7620, the dedicated communication I/F 7630, the positioning unit 7640, the beacon reception unit 7650, the in-vehicle device I/F 7660, and the in-vehicle network I/F 7680 and may generate local map information including surrounding information of a present position of the vehicle. The microcomputer 7610 may predict a danger such as collision of the vehicle, approach of a pedestrian, or entry into a traffic prohibition road based on the obtained information and may generate a warning signal. The warning signal may be, for example, a signal for generating a warning sound or turning on a warning lamp.

The sound/image output unit 7670 transmits an output signal of at least one of sound and an image to an output device capable of visually or audibly providing information to an occupant or to the exterior of the vehicle. In the example illustrated in FIG. 27, an audio speaker 7710, a display unit 7720, and an instrument panel 7730 are illustrated as examples of the output device. The display unit 7720 may include at least one of an on-board display and a heads-up display, for example. The display unit 7720 may have an Augmented Reality (AR) display function. The output device may be another device such as a headphone, a wearable device such as a glasses-type display worn by an occupant, a projector, and a lamp. When the output device is a display device, the display device visually displays results obtained through various processes performed by the microcomputer 7610 or information received from another control unit in various formats such as text, images, tables, and graphs. When the output device is a sound output device, the sound output device converts an audio signal formed by reproduced sound data, acoustic data, or the like into an analog signal and outputs the analog signal auditorily.

In the example illustrated in FIG. 27, at least two control units connected via the communication network 7010 may be integrated as one control unit. Alternatively, each control unit may be constituted by a plurality of control units. Further, the vehicle control system 7000 may include another control unit (not illustrated). Furthermore, in the above description, the other control unit may have some or all of functions of any one of the control units. That is, predetermined calculation processing may be performed by any one of the control units as long as information is transmitted and received via the communication network 7010. Similarly, a sensor or device connected to any one of the control units may be connected to the other control unit, and a plurality of control units may transmit or receive detection information to and from each other via the communication network 7010.

An example of the vehicle control system to which the technique according to the present disclosure can be applied has been described thus far. The technique according to the present disclosure may be applied to the image capturing unit 7410 and the like among the above-described configurations. Specifically, the solid-state imaging device 2 in each embodiment can be applied to the image capturing unit 7410.

The aforementioned embodiments may have the following forms.

(1)

A solid-state imaging device including:
a region classification circuit that divides pixels arranged in an array into each of predetermined regions and classifies each of the predetermined regions obtained by the dividing into a long accumulation region for a long exposure and a short accumulation region for a short exposure;
an exposure time determination circuit that determines an exposure time of the long accumulation region and an exposure time of the short accumulation region classified; and
an exposure control circuit that controls exposure times of the pixels for each of the predetermined regions based on the exposure times determined.
   (2)

The solid-state imaging device according to (1), further including:
a distance detection circuit that generates a range image for an image obtained by the pixels,
wherein the region classification circuit classifies the predetermined regions based on the range image.
   (3)

The solid-state imaging device according to (2), further including:
a luminance detection circuit that detects a luminance value of each of the pixels,
wherein the exposure time determination circuit determines the exposure time of the long accumulation region and the exposure time of the short accumulation region based on each of the luminance values.
   (4)

The solid-state imaging device according to (1), further including:
a histogram generation circuit that generates a histogram of pixel values obtained by the pixels for each of the predetermined regions,
wherein the region classification circuit classifies the regions based on each of the histograms generated.
   (5)

The solid-state imaging device according to (4),
wherein the exposure time determination circuit determines the exposure time of the long accumulation region and the exposure time of the short accumulation region based on the histograms.
   (6)

The solid-state imaging device according to any one of (1) to (5),
wherein readout of pixel values from the pixels is executed through a global shutter method.
   (7)

The solid-state imaging device according to (6), further including:
a readout control circuit that controls a readout timing for each of the predetermined regions classified.
   (8)

The solid-state imaging device according to (7),
wherein each of the pixels includes a pixel memory storing a photoelectrically-converted analog signal, and
the readout control circuit controls a timing of outputting pixel data from each of the pixel memories.
   (9)

The solid-state imaging device according to any one of (1) to (8), further including:
an Analog to Digital Converter (ADC) shared by the pixels belonging to a corresponding one of the predetermined regions.
   (10)

The solid-state imaging device according to any one of (1) to (9),
wherein the long accumulation region and the short accumulation region can be set to overlap.
   (11)

The solid-state imaging device according to (10),
wherein pixels that receive infrared light provided as the pixels, and
the infrared light is received by the pixels that receive the infrared light at a timing at which a long exposure is performed in the long accumulation region.
   (12)

The solid-state imaging device according to (11), further including:
an LED that emits the infrared light.
   (13)

The solid-state imaging device according to (11) or (12),
wherein all the predetermined regions are classified as the short accumulation region.

The aspects of the present disclosure are not limited to the embodiments described above and include various modifications that are conceivable, and effects of the present disclosure are not limited to the above-described content. Constituent elements of the embodiments may be appropriately combined for an application. In other words, various additions, modifications, and partial deletions can be made without departing from the conceptual ideas and spirit of the present disclosure that can be derived from the details defined in the claims and the equivalents thereof.

### REFERENCE SIGNS LIST

1 Semiconductor substrate
10 First substrate
11 Second substrate
100 Pixel array
101 Pixel
102 Pixel driving circuit
103 Time code generation circuit
104 Time code transfer circuit
105 Pixel circuit
110 ADC
111 Output circuit
112 Sense amplifier
113 Vertical scanning circuit
114 Timing generation circuit
115 DAC
116 Differential input circuit
117 Voltage conversion circuit
118 Positive feedback circuit
120 PD
121 Discharge transistor
122 Transfer transistor
123 Reset transistor
124 FD
130, 131, 132, 133, 134, 135 Transistor
140 Transistor
150, 151, 152, 153, 154, 155, 156 Transistor
2 Solid-state imaging device
200 Data processing circuit
202 Distance detection circuit
204 Luminance detection circuit
206 Region classification circuit
208 Exposure time determination circuit
210 Exposure control circuit
212 Output I/F
214 Communication/control circuit

1. A solid-state imaging device comprising:
a region classification circuit that divides pixels arranged in an array into each of predetermined regions and classifies each of the predetermined regions obtained by the dividing into a long accumulation region for a long exposure and a short accumulation region for a short exposure;
an exposure time determination circuit that determines an exposure time of the long accumulation region and an exposure time of the short accumulation region classified; and
an exposure control circuit that controls exposure times of the pixels for each of the predetermined regions based on the exposure times determined.

2. The solid-state imaging device according to claim 1, further comprising:
a distance detection circuit that generates a range image for an image obtained by the pixels,
wherein the region classification circuit classifies the predetermined regions based on the range image.

3. The solid-state imaging device according to claim 2, further comprising:
a luminance detection circuit that detects a luminance value of each of the pixels,
wherein the exposure time determination circuit determines the exposure time of the long accumulation region and the exposure time of the short accumulation region based on each of the luminance values.

4. The solid-state imaging device according to claim 1, further comprising:
a histogram generation circuit that generates a histogram of pixel values obtained by the pixels for each of the predetermined regions,
wherein the region classification circuit classifies the regions based on each of the histograms generated.

5. The solid-state imaging device according to claim 4,
wherein the exposure time determination circuit determines the exposure time of the long accumulation region and the exposure time of the short accumulation region based on the histograms.

6. The solid-state imaging device according to claim 1,
wherein readout of pixel values from the pixels is executed through a global shutter method.

7. The solid-state imaging device according to claim 6, further comprising:
a readout control circuit that controls a readout timing for each of the predetermined regions classified.

8. The solid-state imaging device according to claim 7,
wherein each of the pixels includes a pixel memory storing a photoelectrically-converted analog signal, and
the readout control circuit controls a timing of outputting pixel data from each of the pixel memories.

9. The solid-state imaging device according to claim 1, further comprising:
an Analog to Digital Converter (ADC) shared by the pixels belonging to a corresponding one of the predetermined regions.

10. The solid-state imaging device according to claim 1,
wherein the long accumulation region and the short accumulation region can be set to overlap.

11. The solid-state imaging device according to claim 10,
wherein pixels that receive infrared light provided as the pixels, and
the infrared light is received by the pixels that receive the infrared light at a timing at which a long exposure is performed in the long accumulation region.

12. The solid-state imaging device according to claim 11, further comprising:
an LED that emits the infrared light.

13. The solid-state imaging device according to claim 11,
wherein all the predetermined regions are classified as the short accumulation region.
